(19) United States
(12) Patent Application Publication
(10) Pub. No.: US 2008/0124552 A1
(43) Pub. Date: May 29, 2008

(54) Particle With Rough Surface For Plating Or Vapor Deposition

(75) Inventors: Toshifumi Hashiba, Chiba (JP); Nami Tsukamoto, Chiba (JP); Kazutoshi Hayakawa, Chiba (JP); Satomi Kudo, Chiba (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Nisshinbo Industries, Inc., Tokyo (JP)

(21) Appl. No.: 11/569,462

(22) PCT Filed: May 24, 2005
(86) PCT No.: PCT/JP05/09458

§ 371 Date: Nov. 21, 2006

(30) Foreign Application Priority Data
May 24, 2004 (JP) 2004-152953

(51) Int. Cl. B32B 5/16

(52) U.S. Cl. 428/407

(57) ABSTRACT

A particle with a rough surface for plating or vapor deposition which has been formed from a base (A) having first functional groups on the surface thereof and particles (B) having on the surface thereof second functional groups reactive with the first functional groups and having an average particle diameter which is smaller than the diameter of the base (A) and not smaller than 0.1 μm, by uniting the base (A) with the particles (B) through chemical bonds between the first functional groups and the second functional groups, wherein the base (A) has at least two projecting parts on the surface thereof. In this particle, the base has been tenaciously bonded to the protruding particles. Because of this, even when the protruding particles used have a size not smaller than the given size, the particle with a rough surface can secure a surface area while maintaining a thickness of a conductive coating film. As a result, the particle can have high conductivity.

### TECHNICAL FIELD

The present invention relates to a rough particle for plating or vapor deposition treatment.

### BACKGROUND ART

Increased efforts have been devoted recently to the development of micron-size particles. For example, the use of such particles in a broad range of applications, including plastic resin modifiers, functionalizing agents for paints and coatings, organic pigments, electronic materials, toner particles, optical materials, separation materials, bonding adhesives, pressure-sensitive adhesives, food products, cosmetics and biochemical carriers, is under investigation.

In the area of electrical and electronics materials in particular, anticipated applications include use as electrically conductive fillers obtained by subjecting the surface of a plastic material or the like to plating or other treatment so as to impart conductivity thereto, and as other electrically conductive materials for connecting the electrodes of a liquid-crystal display panel with a driving LSI chip, for connecting a LSI chips to a circuit board, or for connecting between other very-small-pitch electrode terminals.

In particular, particles having asperities at the surface (referred to below as “rough particles”) enable the surface area of the particles themselves to be increased, making it possible to impart high conductivity characteristics.

In general, such rough particles are almost always produced by using an electrical or physical technique to cause fine particles intended to serve as protrusions to adhere to the surface of a core particle.

When the core particles and/or the fine particles intended to serve as protrusions thereon are polymer particles, studies have been carried out on producing rough particles by using, for example, collision forces, heat or a solvent to cause the solidified particles to unite by fusing together or by embedment of the respective particles (Patent Document 1: Japanese Patent No. 2762507; Patent Document 2: Japanese Patent No. 3374593).

However, rough particles obtained by electrical adhesion using a static charge, for example, or by physical adhesion involving impact forces, have a serious drawback: the protrusions have a tendency to come off the core particle. This may have undesirable consequences during a plating treatment operation or the like.

In the case of adhesion by embedment involving thermal fusion or adhesion that utilizes mechanical and thermal energy applied by, for example, a hybridization system, the problem of protrusions coming off is resolved to some degree. Yet, such solutions are far from perfect, given that this problem may also be strongly affected by the glass transition points and softening temperatures of the core particle and the protrusions. Moreover, there is a strong possibility that, during plating treatment or the like, undesirable effects will occur, such as variations in adherence between particles, in particle agglomeration and in particle size, and damage to the particles.

One solution that has been described involves the coating of particles by chemically bonding together different types of particles having reactive functional groups on their respective surfaces (Patent Document 3: JP-A 2001-342377).

The art in this Patent Document 3 is relatively useful when the coating particles are of a very small size. Moreover, by carrying out plating treatment, it is possible to obtain very fine particles that are electrically conductive.

Plating layers of relatively substantial thicknesses in excess of 0.1 μm are becoming the norm recently due to improvements in plating technology. Yet, when plating treatment is administered to the rough particles in Patent Document 3, as the thickness of the metal plating layer increases, the degree of roughness that was achieved by particle coating vanishes, making it impossible to expect high electrical conductivity characteristics having a good reproducibility to be conferred.

Moreover, while a number of ways are conceivable for increasing the size of the protruding particles on the rough particles so that asperities on the rough particles do not vanish even after plating treatment, such techniques increase the surface area of loading, leading to another problem; namely, a greater tendency for the protrusions to come off the rough particles.

Accordingly, there exists a desire for rough particles in which, even when the size of the protruding particles has been increased and the rough particles have been covered with an electrically conductive layer, e.g., a plating layer, of a relatively substantial thickness, the protruding particles are strongly bonded and do not come off, thus making it possible to provide plated particles having a sufficiently rough surface.

Patent Document 1: Japanese Patent No. 2762507

Patent Document 2: Japanese Patent No. 3374593

Patent Document 3: JP-A 2001-342377

### DISCLOSURE OF THE INVENTION

### Problems to be Solved by the Invention

It is therefore an object of the invention to provide rough particles for plating or vapor deposition in which, even when protruding particles of at least a given size are used, the base material and the protruding particles are strongly bonded together, enabling a large surface area to be achieved while retaining an electrically conductive coating layer of substantial thickness, so that the rough particles are able to exhibit a high electrical conductivity.

### Means for Solving the Problems

As a result of extensive investigations, the inventors have discovered that, in a rough particle for plating or vapor deposition which is composed of (A) a particle having on a surface thereof a first functional group and (B) a particle having on a surface thereof a second functional group capable of reacting with the first functional group and having a given average particle size, which (A) and (B) particles are united by chemical bonds between the respective functional groups and wherein the surface of the (A) particle has at least two protrusions thereon, the bond between the (A) particle and the (B) particle is strong, making it difficult for the (B) particle to come off. The inventors have also discovered that when the rough particle is administered plating or vapor deposition treatment, a large surface area can be achieved while retaining a conductive coating layer of substantial thickness, thus enabling an electrically conductive rough particle having a high electrical conductivity to be obtained.

Accordingly, the invention provides the following.

(1) A rough particle for plating or vapor deposition, characterized by comprising (A) a particle having on a surface thereof a first functional group and (B) a particle having on a surface thereof a second functional group capable of reacting with the first functional group and having an average particle size of at least 0.1 μm but less than the average particle size of particle (A), which (B) and (B) particles are united by chemical bonds between the first and second functional groups; wherein the surface of the (A) particle has at least two protrusions thereon.

(2) The rough particle for plating or vapor deposition of (1), characterized in that the chemical bonds are covalent bonds.

(3) The rough particle for plating or vapor deposition of (1) or (2), characterized in that the (A) particle or the (B) particle or both have a functional group-containing polymeric compound grafted from the surface thereof.

(4) The rough particle for plating or vapor deposition of (3), characterized in that functional group-containing polymeric compound has a number-average molecular weight of from 500 to 100,000.

(5) The rough particle for plating or vapor deposition of (3) or (4), characterized in that the functional group-containing polymeric compound has an average of at least two functional groups per molecule.

(6) The rough particle for plating or vapor deposition of (5), characterized in that the functional group-containing polymeric compound has a functional group equivalent weight of from 50 to 2,500.

(7) The rough particle for plating or vapor deposition of any of (1) to (6), characterized in that the first functional group or the second functional group or both is at least one selected from the group consisting of active hydrogen groups, carbodiimide groups, oxazoline groups and epoxy groups.

(8) The rough particle for plating or vapor deposition of (7), characterized in that the first functional group or the second functional group or both is a carbodiimide group.

(9) The rough particle for plating or vapor deposition of any one of (1) to (8), characterized in that the (B) particle has an average particle size of from 0.15 to 30 μm.

(10) The rough particle for plating or vapor deposition of any one of (1) to (9), characterized in that the (A) particle is a spherical or substantially spherical particle.

(11) The rough particle for plating or vapor deposition of any one of (1) to (10), characterized in that the (A) particle is an organic polymer particle.

(12) The rough particle for plating or vapor deposition of any one of (1) to (11), characterized in that the (A) particle has an average particle size of from 0.5 to 100 μm.

### EFFECTS OF THE INVENTION

In the inventive rough particle for plating or vapor deposition, because (A) a particle having on a surface thereof a first functional group and (B) a particle having on a surface thereof a second functional group capable of reacting with the first functional group are united by chemical bonds between the first and second functional groups, the bond between the (A) particle and the (B) particle is strong, preventing the (B) particle from easily coming off. Moreover, because the (B) particle has an average particle size of at least 0.1 μm but less than the average particle size of particle (A), the rough particle can be imparted with asperities having a sufficient height difference.

Hence, even when an electrically conductive film of a relatively large thickness of 0.1 μm or more is formed on this rough particle, sufficient asperities can be retained on the particle, enabling a large surface area to be achieved and thus making it possible to obtain an electrically conductive rough particle having a high conductivity.

Electrically conductive rough particles having such a high conductivity can be put to excellent use as various types of conductive materials, including electrically conductive fillers which impart conductivity to plastic materials and the like, and conductive materials for connection in electrical and electronic devices, such as to connect the electrodes of a liquid-crystal display panel with a driving LSI chip, to connect a LSI chip with a circuit board, or to connect between very-small-pitch electrode terminals.

### BRIEF DESCRIPTION OF THE DIAGRAMS

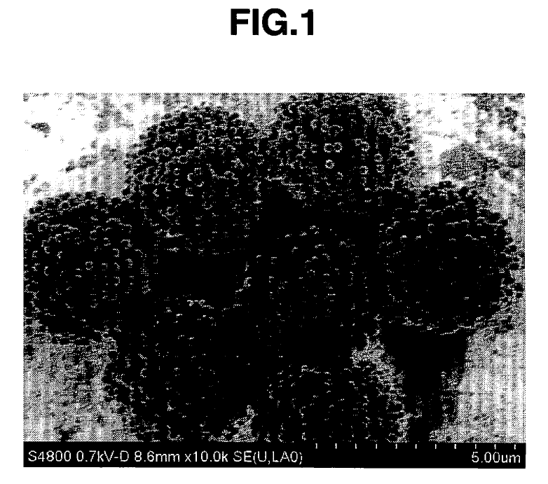

FIG. 1 is scanning electron micrograph of a rough particle for plating or vapor deposition treatment obtained in Example 1. In FIG. 1, each line on the scale represents 0.5 μm.

### BEST MODE FOR CARRYING OUT THE INVENTION

The invention is described more fully below.

The inventive rough particle for plating or vapor deposition is characterized by being composed of (A) a particle having on a surface thereof a first functional group and (B) a particle having on a surface thereof a second functional group capable of reacting with the first functional group and having an average particle size of at least 0.1 μm but less than the average particle size of particle (A), which (A) and (B) particles are united by chemical bonds between the first and second functional groups. The (A) particle has at least two protrusions on the surface thereof.

As used herein, “particle” is a concept which encompasses forms dispersed in a solvent, such as emulsions. The particles may be cured particles or particles in a semi-cured state.

The chemical bonds are not subject to any particular limitation, provided they are chemical bonds such as covalent bonds, coordinate bonds, ionic bonds or metallic bonds. However, to make the bonds between the (A) particles and the (B) particles more secure, it is preferable for the chemical bonds to be covalent bonds.

In the rough particle of the invention, a “protrusion” refers to a portion of the rough particle that originates from a (B) particle. This protrusion may be formed with a single (B) particle (primary particle) or may be formed by the agglomeration of a plurality of (B) particles.

The number of protrusions is not subject to any particular limitation, provided at least two are present on the surface of the (A) particle. However, because the preferred number will vary depending on the surface area of the (A) particle, the average particle size of the (B) particles and other factors, it is desirable to select a suitable number based on such considerations as the thickness of the electrically conductive film to be applied to the rough particle and the spacing between the protrusions.

The spacing between the protrusions may be set as desired so as to be either uniform or random. This spacing may be altered by varying such conditions as the particle diameters of the (A) particles and the (B) particles, the types of functional groups, the contents of the functional groups, the proportions in which the (A) particles and the (B) particles are used, and the reaction temperature.

The (A) particles and (B) particles are not subject to any particular limitation with regard to shape, and may be given any suitable particle shape. However, given the desire recently for rough particles of a higher precision, it is preferable for at least the (A) particles to be spherical or substantially spherical particles.

In the rough particle of the invention, as noted above, the (B) particle has an average particle size which is at least 0.1 μm but less than the average particle size of the (A) particle, and preferably not more than ½, more preferably not more than ⅕, and even more preferably not more than ⅛, the average particle size of the (A) particle. The upper limit in the average particle size of the (B) particle is preferably about 100 μm. At an average particle size below 0.1 μm, there is a strong possibility that the protrusions formed by (B) particles will be buried by the electrically conductive film, preventing the high electrical conductivity associated with the increase in surface area particular to the asperities from being achieved, and perhaps even failing to result in any improvement in properties over those of conventional plated particles. On the other hand, at an average particle size greater than 100 μm, although protrusions can be added to the (A) particles, the surface area under load becomes too large, which may have adverse effects such as a loss of adhering (B) particles (protrusions).

In the electrically conductive rough particles obtained by subjecting the rough particles to plating or vapor deposition treatment, to improve the electrical conductivity even further by increasing the thickness of the plating film while yet retaining the surface roughness due to the protrusions, it is desirable for the (B) particle to have an average particle size with a lower limit of preferably at least 0.15 μm, and more preferably at least 0.2 μm. The upper limit in the average particle size is preferably not more than 50 μm, more preferably not more than 10 μm, and even more preferably not more than 3 μm.

The average particle size of the (A) particles varies with the average particle size of the (B) particles, and thus cannot be strictly specified, although an average particle size in a range of about 0.5 to about 100 μm is preferred. Outside of this average particle size range, using metal particles alone may be less expensive and there may be little advantage to using electrically conductive particles composed of rough particles. The average particle size of the (A) particles is more preferably from 0.8 to 50 μm, and even more preferably from 1.0 to 10 μm.

In this invention, “average particle size” refers to the average value obtained by using a scanning electron microscope (S-4800 manufactured by Hitachi, Ltd.; referred to below as “SEM”) to photograph the particles (n=300) at a measurable magnification (from 300 to 20,000×), and measuring the particle diameters on the two-dimensional particle images.

No particular limitation is imposed on the materials making up the (A) particles and the (B) particles. Both may be made of either organic materials or inorganic materials (including metallic materials). However, for use as an electrically conductive material after plating or vapor deposition treatment, it is desirable that the particles not have a high specific gravity. Moreover, because resilience may be required, it is preferable for at least the (A) particle to be made of an organic material. It is most preferable for the (A) particle to be an organic polymer particle.

The (A) particles and the (B) particles here may both have a single-layer structure, or they may have a multilayer structure in which a surface is covered with a coating ingredient. In such a case, for both the (A) particles and the (B) particles, the coating ingredient may be any suitable substance, provided the surface of the particle has functional groups. For example, the surfaces of the respective particles may be polymeric compound coats containing the first or second functional group.

The organic material is exemplified by crosslinked and non-crosslinked resin particles, organic pigments and waxes.

Illustrative examples of the crosslinked and non-crosslinked resin particles include styrene resin particles, acrylic resin particles, methacrylic resin particles, polyfunctional vinyl resin particles, polyfunctional (meth)acrylate resin particles, polyethylene resin particles, polypropylene resin particles, silicone resin particles, polyester resin particles, polyurethane resin particles, polyamide resin particles, epoxy resin particles, polyvinyl butyral resin particles, rosin particles, terpene resin particles, phenolic resin particles, melamine resin particles and guanamine resin particles.

Illustrative examples of organic pigments include azo pigments, polycondensed azo pigments, metal complex azo pigments, benzimidazolone pigments, phthalocyanine pigments (blue, green), thioindigo pigments, anthraquinone pigments, flavanthrone pigments, indanthrene pigments, anthrapyridine pigments, pyranthrone pigments, isoindolinone pigments, perylene pigments, perinone pigments and quinacridone pigments.

Illustrative examples of waxes include natural waxes of vegetable origin, such as candelilla wax, carnauba wax and rice wax; natural waxes of animal original, such as beeswax and lanolin; natural waxes of mineral origin, such as montan wax and ozbkerite; natural, petroleum-based waxes such as paraffin wax, microcrystalline wax and petrolatum; synthetic hydrocarbon waxes such as polyethylene wax and Fischer-Tropsch wax; modified waxes such as montan wax derivatives and paraffin wax derivatives; hydrogenated waxes such as hardened castor oil derivatives; and synthetic waxes.

Of the various above organic materials, based on such considerations as the ease of acquiring particles having a uniform particle size, the ease of conferring functional groups and the monodispersibility of the particles, it is especially preferable to use crosslinked and non-crosslinked resin particles. Specifically, the use of vinyl resin particles such as styrene resin particles, acrylic resin particles, methacrylic resin particles, polyfunctional vinyl resin particles and polyfunctional (meth)acrylate resin particles is preferred.

These types of resin particles may be used singly or as combinations of two or more thereof.

Illustrative examples of inorganic materials include any of the following in the form of a powder or fine particles: alumina, titanium oxide, barium titanate, magnesium titanate, calcium titanate, strontium titanate, zinc oxide, silica sand, clay, mica, wollastonite, diatomaceous earth, chromium oxide, cerium oxide, iron oxide, antimony trioxide, magnesium oxide, zirconium oxide, aluminum oxide, magnesium hydroxide, aluminum hydroxide, barium sulfate, barium carbonate, calcium carbonate, silica, silicon carbide, silicon nitride, boron carbide, tungsten carbide, titanium carbide and carbon black; metals such as gold, platinum, palladium, silver, ruthenium, rhodium, osmium, iridium, iron, nickel, cobalt, copper, zinc, lead, aluminum, titanium, vanadium, chromium, manganese, zirconium, molybdenum, indium, antimony and tungsten, as well as alloys, metal oxides and hydrated metal oxides thereof; and inorganic pigments, carbon, and ceramics. These may be used singly or as combinations of two or more thereof.

The above organic materials and inorganic materials, if available as commercial products, may be used directly in the commercially available form, or such commercial products may be used following modification with a surface treatment agent such as a coupling agent.

Illustrative, non-limiting, examples of the surface treatment agent include unsaturated fatty acids, such as oleic acid: the metal salts of unsaturated fatty acids, such as sodium oleate, calcium oleate and potassium oleate; fatty acid esters; fatty acid ethers; surfactants; silane coupling agents, including such alkoxysilanes as methacryloxymethyltrimethoxysilane, methacryloxypropyltrimethoxysilane, n-octadecylmethyldiethoxysilane, dodecyltrimethoxysilane, 2-(3,4-epoxycyclohexyl)ethyltrimethoxysilane, 2-(4-chlorosulfonyl)ethyltrimethoxysilane, triethoxysilane, vinyltrimethoxysilane and phenethyltrimethoxysilane; titanate coupling agents; and aluminum coupling agents.

Preferred combinations of the (A) particles and the (B) particles are exemplified as follows.

### (1) Particle (A)

Styrene resin particles, acrylic resin particles, methacrylic resin particles, divinyl resin particles, di(meth)acrylate resin particles, etc.

### (2) Particle (B)

Alumina, silica, titanium oxide, zinc oxide, magnesium hydroxide, aluminum hydroxide, etc.

In particular, for use as an electronic material having properties such as anisotropic conductivity, depending on the particular type of material, the rough particle may need to have such qualities as hardness and resilience. In light of this, resin particles obtained using a polyfunctional vinyl group-containing compound are preferred. It is even more preferable for such resin particles capable of serving as (A) particles or (B) particles to be copolymeric resin particles containing at least one compound selected from among divinyl compounds and di(meth)acrylate compounds.

The first functional group present at the surface of the (A) particle and the second functional group present at the surface of the (B) particle are not subject to any particular limitation, and may be selected in any desired combination that allows chemical bonding to occur between both functional groups.

Specific examples of the functional groups include vinyl, aziridine, oxazoline, epoxy, thioepoxy, amide, isocyanate, carbodulmide, acetoacetyl, carboxyl, carbonyl, hydroxyl, amino, aldehyde, mercapto and sulfonic acid groups.

It is preferable for the (A) particle or the (B) particle or both to have at least one type of functional group selected from among the following which have a high reactivity and are capable of easily forming strong bonds: active hydrogen groups (e.g., amino, hydroxyl, carboxyl, mercapto), carbodiimide groups, epoxy groups and oxazoline groups. From the standpoint of further increasing adherence between the (A) and (B) particles and increasing adhesion of the plating film or other electrically conductive film to the rough particle, a carbodiimide group is especially preferred.

Preferred used can be made of active hydrogen groups (e.g., amino, hydroxyl, carboxyl, mercapto) because many organic compounds contain such groups, and because a plurality of functional groups can easily be added by radical polymerization or the like. The above first and second functional groups can each be used singly or as combinations of two or more thereof.

Functional group-containing compounds which may be used in the invention are exemplified by the following compounds.

### (1) Vinyl Group-Bearing Compounds

Examples of vinyl group-bearing compounds include (i) styrene compounds such as styrene, o-methylstyrene, m-methylstyrene, p-methylstyrene, α-methylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-phenylstyrene, p-chlorostyrene, and 3,4-dichlorostyrene; (ii) (meth)acrylate esters such as methyl acrylate, ethyl acrylate, n-butyl acrylate, isobutyl acrylate, propyl acrylate, hexyl acrylate, 2-ethylhexyl acrylate, n-octyl acrylate, dodecyl acrylate, lauryl acrylate, stearyl acrylate, 2-chloroethyl acrylate, phenyl acrylate, methyl a-chloroacrylate, methyl methacrylate, ethyl methacrylate, n-butyl methacrylate, isobutyl methacrylate, propyl methacrylate, hexyl methacrylate, 2-ethylhexyl methacrylate, n-octyl methacrylate, dodecyl methacrylate, lauryl methacrylate and stearyl methacrylate; (iii) vinyl esters such as vinyl acetate, vinyl propionate, vinyl benzoate and vinyl butyrate; (iv) (meth)acrylic acid derivatives such as acrylonitrile and methacrylonitrile; (v) vinyl ethers such as vinyl methyl ether, vinyl ethyl ether and vinyl isobutyl ether; (vi) vinyl ketones such as vinyl methyl ketone, vinyl hexyl ketone and methyl isopropenyl ketone; (vii) N-vinyl compounds such as N-vinylpyrrole, N-vinylcarbazole, N-vinylindole and N-vinylpyrrolidone; (viii) vinyl fluoride, vinylidene fluoride, tetrafluoroethylene, hexafluoropropylene, and fluoroalkyl group-bearing (meth)acrylate esters such as trifluoroethyl acrylate and tetrafluoropropyl acrylate; and (ix) polyfunctional vinyl group-bearing compounds such as divinylbenzene, divinylbiphenyl, divinylnaphthalene, (poly)alkylene glycol di(meth)acrylates such as (poly)ethylene glycol di(meth)acrylate, (poly)propylene glycol di(meth)acrylate and (poly)tetramethylene glycol di(meth)acrylate, alkanediol di(meth)acrylates such as 1,6-hexanediol di(meth)acrylate, 1,8-octanediol di(meth)acrylate, 1,9-nonanediol di(meth)acrylate, 1,10-decanediol di(meth)acrylate, 1,12-dodecanediol di(meth)acrylate, 3-methyl-1,5-pentanediol di(meth)acrylate, 2,4-diethyl-1,5-pentanediol di(meth)acrylate, butylethylpropanediol di(meth)acrylate, 3-methyl-1,7-octanediol di(meth)acrylate and 2,-methyl-1,8-octanediol di(meth)acrylate, neopentyl glycol di(meth)acrylate, trimethylolpropane tri(meth)acrylate, tetramethylolmethane tri(meth)acrylate, tetramethylolpropane tetra(meth)acrylate, pentaerythritol tri(meth)acrylate, ethoxylated cyclohexanedimethanol di(meth)acrylate, ethoxylated bisphenol A di(meth)acrylate, tricyclodecanedimethanol di(meth)acrylate, propoxylated ethoxylated bisphenol A di(meth)acrylate, 1,1,1-tris(hydroxymethylethane) di(meth)acrylate, 1,1,1-tris(hydroxymethylethane) tri(meth)acrylate, 1,1,1-tris(hydroxymethylpropane) triacrylate, diallyl phthalate and isomers thereof, and triallyl isocyanurate and derivatives thereof. These may be used singly or as combinations of two or more thereof.

### (2) Aziridine Group-Bearing Compounds

Examples of aziridine group-bearing compounds include acryloylaziridine, methacryloylaziridine, 2-aziridinyl ethyl acrylate and 2-aziridinyl ethyl methacrylate. These may be used singly or as combinations of two or more thereof.

### (3) Oxazoline Group-Bearing Compounds

Oxazoline group-bearing compounds that may be used in the invention are not subject to any particular limitation, although preferred compounds include those having two or more oxazoline rings.

Specific examples include unsaturated double bond-containing monomers having an oxazoline group, such as 2-vinyl-2-oxazoline, 2-vinyl-4-methyl-2-oxazoline and 2-vinyl-5-methyl-2-oxazoline, as well as (co)polymers obtained by addition polymerization or the like thereof; bisoxazoline compounds such as 2,2′-bis(2-oxazoline), 2,2′-bis(4-methyl-2-oxazoline), 2,2′-bis(5-methyl-2-oxazoline), 2,2′-bis(5,5′-dimethyloxazoline), 2,2′-bis(4,4,4′,4′-tetramethyl-2-oxazoline), 1,2-bis(2-oxazolin-2-yl)ethane, 1,4-bis(2-oxazolin-2-yl)butane, 1,6-bis(2-oxazolin-2-yl)hexane, 1,4-bis(2-oxazolin-2-yl)cyclohexane, 1,2-bis(2-oxazolin-2-yl)benzene, 1,3-bis(2-oxazolin-2-yl)benzene, 1,4-bis(2-oxazolin-2-yl)benzene, 1,2-bis(5-methyl-2-oxazolin-2-yl)benzene, 1,3-bis(5-methyl-2-oxazolin-2-yl)benzene, 1,4-bis(5-methyl-2-oxazolin-2-yl)benzene and 1,4-bis(4,4′-dimethyl-2-oxazolin-2-yl)benzene, as well as compounds with terminal oxazoline groups obtained by reacting two chemical equivalents of the oxazoline groups on these bisoxazoline compounds with one chemical equivalent of carboxyl groups on a polybasic carboxylic acid (e.g., maleic acid, succinic acid, itaconic acid, phthalic acid, tetrahydrophthalic acid, hexahydrophthalic acid, methylhexahydrophthalic acid, chlorendic acid, trimellitic acid, pyromellitic acid, benzophenonetetracarboxylic acid). These may be used singly or as combinations of two or more thereof.

Use can be made of commercial oxazoline group-bearing compounds, examples of which include the following Epocros series products: WS-500, WS-700, K-1010E, K-2010E, K-1020E, K-2020E, K-1030E, K-2030E and RPS-1005 (all products of Nippon Shokubai Co., Ltd.).

Given the frequent use lately of water or water-soluble solvents in plating treatment operations so as to reduce the impact on the environment, it is preferable to use a water-soluble or hydrophilic compound as the oxazoline group-bearing compound. Specific examples include such water-soluble oxazoline group-bearing compounds as WS-500 and WS-700 within the above Epocros series.

### (4) Epoxy Group-Bearing Compounds

Epoxy group-bearing compounds that may be used in the invention are not subject to any particular limitation, although a compound having two or more epoxy groups is preferred.

Specific examples include epoxy group-bearing monomers, such as glycidyl (meth)acrylate, (β-methyl)glycidyl (meth)acrylate, 3,4-epoxycyclohexyl (meth)acrylate, allyl glycidyl ether, 3,4-epoxyvinylcyclohexane, di(β-methyl)glycidyl malate and di(β-methyl)glycidyl fumarate; glycidyl ethers of aliphatic polyols, such as ethylene glycol diglycidyl ether, propylene glycol diglycidyl ether, hexamethylene glycol diglycidyl ether, cyclohexanediol diglycidyl ether, glycerol triglycidyl ether, trimethylolpropane triglycidyl ether and pentaerythritol tetraglycidyl ether; glycidyl ethers of polyalkylene glycols, such as polyethylene glycol diglycidyl ether, polypropylene glycol diglycidyl ether and polytetramethylene glycol diglycidyl ether; polyester resin-based polyglycidyl compounds; polyamide resin-based polyglycidyl compounds; bisphenol A-based epoxy resins; phenolic novolak-based epoxy resins; and epoxyurethane resins. These may be used alone or any two or more may be used together. These may be used singly or as combinations of two or more thereof.

Use can be made of commercial epoxy group-bearing compounds, examples of which include the following Denacol series products: Denacol EX-611, -612, -614, -614B, -622, -512, -521, -411, -421, -313, -314, -321, -201, -211, -212, -252, -810, -811, -850, -851, -821, -830, -832, -841, -861, -911, -941, -920, -931, -721, -111, -212L, -214L, -216L, -321L, -850L, -1310, -1410, -1610 and -610U (all products of Nagase ChemteX Corporation).

Here too, given the frequent use lately of water or water-soluble solvents in plating treatment operations so as to reduce the impact on the environment, it is preferable to use a water-soluble or hydrophilic compound as the epoxy group-bearing compound. Of the above epoxy group-bearing compounds, specific examples include the following water-soluble epoxy group-bearing compounds: (poly)alkylene glycol diglycidyl ethers such as (poly)ethylene glycol diglycidyl ether and (poly)propylene glycol diglycidyl ether; (poly)glycerol polyglycidyl ethers such as glycerol polyglycidyl ether and diglycerol polyglycidyl ether; and water-soluble epoxy group-bearing compounds such as sorbitol polyglycidyl ethers.

### (5) Amide Group-Bearing Compounds

Examples of amide group-bearing compounds include (meth)acrylamide, a-ethyl (meth)acrylamide, N-methyl (meth)acrylamide, N-butoxymethyl (meth)acrylamide, diacetone (meth)acrylamide, N,N-dimethyl (meth)acrylamide, N,N-diethyl (meth)acrylamide, N,N-dimethyl-p-styrenesulfonamide, N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N-[2-(meth)acryloyloxyethyl]piperidine, N-[2-(meth)acryloyloxyethylene]pyrrolidine, N-[2-(meth)acryloyloxyethyl]morpholine, 4-N,N-dimethylamino)styrene, 4-(N,N-diethylamino)styrene, 4-vinylpyridine, 2-dimethylaminoethyl vinyl ether, 2-diethylaminoethyl vinyl ether, 4-dimethylaminobutyl vinyl ether, 4-diethylaminobutyl vinyl ether and 6-dimethylaminohexyl vinyl ether. These may be used singly or as combinations of two or more thereof.

### (6) Isocyanate Group-Bearing Compounds

Isocyanate group-bearing compounds that may be used in the invention, while not subject to any particular limitation, are preferably polyfunctional isocyanate group-bearing compounds. Illustrative examples include 4,4′-dicyclohoexylmethane diisocyanate, m-tetramethylxylylene diisocyanate, 2,4-tolylene diisocyanate, 2,6-tolylene diisocyanate, mixtures of 2,4-tolylene diusocyanate and 2,6-tolylene diisocyanate, crude tolylene diisocyanate, crude methylene diphenyl diisocyanate, 4,4′,4″-triphenylmethylene triisocyanate, xylylene diisocyanate, hexamethylene-1,6-diusocyanate, tolidine diisocyanate, hydrogenated methylenediphenyl diusocyanate, m-phenyl diusocyanate, naphthalene-1,5-duisocyanate, 4,4′-biphenylene diisocyanate, 4,4′-diphenylmethane dlisocyanate, 3,3′-dimethoxy-4,4′-biphenyl diisocyanate, 3,3′-dimethyldiphenylmethane-4,4-diisocyanate and isophorone diisocyanate. These may be used singly or as combinations of two or more thereof.

### (7) Carbodiimide Group-Bearing Compounds

Carbodiimide group-bearing compounds that may be used in the present invention are not subject to any particular limitation. Examples include compounds of the following formula.

A^{x}—(R¹−X)ₙ—R²—A^{y} (I)

### In the formula, A^{x} and A^{y} are each independently like or unlike segments, R¹ and R² are each independently organic groups having a valence of two or more, X is a carbodiimide group, and the letter n is an integer of 2 or more.

Examples of the organic group having a valence of two or more include hydrocarbon groups, and organic groups which include a nitrogen or oxygen atom. A divalent hydrocarbon group is preferred. Examples of divalent hydrocarbon groups include C₁ to C₁₆ alkylene groups which may be linear, branched or cyclic, C₆ to C₁₆ aryl groups, and C₇ to C₁₈ aralkyl groups.

Carboduimide compounds of above formula (I) can be prepared in the presence of a catalyst which promotes conversion of the isocyanate group on an organic polyisocyanate compound to a carbodiimide group.

For example, such preparation can be carried out by the method disclosed in JP-A 51-61599, the method of L. M. Alberino et al. (J. Appl. Polym. Sci., 21, 190 (1990)), or the method disclosed in JP-A 2-292316.

Organic polyisocyanate compounds which may serve as the starting material are exemplified by the same compounds as the isocyanate group-bearing compounds mentioned in (7) above.

The carbodlimide-forming reaction is carried out by heating the isocyanate compound in the presence of a carbodiimidation catalyst. At this time, the molecular weight (degree of polymerization) can be adjusted by adding at an appropriate stage, as an end-capping agent, a compound having a functional group capable of reacting with the isocyanate group and thereby capping (converting to segments) the ends of the carboduimide compound. The degree of polymerization can also be adjusted by means of such parameters as the concentration of, for example, the polyisocyanate compounds and the reaction time. Depending on the intended application, it is also possible to carry out the reaction without capping the ends; that is, with the isocyanate groups left unmodified.

The end-capping agent is exemplified by compounds having a hydroxyl group, a primary or secondary amino group, a carboxyl group, a thiol group or an isocyanate group. By capping (converting to segments) the ends of the carbodiimide compound, the molecular weight (degree of polymerization) can be adjusted.

Here too, given the frequent use lately of water or water-soluble solvents in plating treatment operations so as to reduce the impact on the environment, it is preferable to use a compound having water-soluble or hydrophilic segments as the carbodiimide compound.

The water-soluble or hydrophilic segments (A^{x} and A^{y} ) in the above formula are not subject to any particular limitation, provided they are segments capable of making the carbodiimide compound water-soluble. Specific examples include alkylsulfonate residues having at least one reactive hydroxyl group, such as sodium hydroxyethanesulfonate and sodium hydroxypropanesulfonate; quaternary salts of dialkylaminoalcohol residues such as 2-dimethylaminoethanol, 2-diethylaminoethanol, 3-dimethylamino-1-propanol, 3-diethylamino-1-propanol, 3-diethylamino-2-propanol, 5-diethylamino-2-propanol and 2-(di-n-butylamino)ethanol; quaternary salts of dialkylaminoalkylamine residues such as 3-dimethylamino-n-propylamine, 3-diethylamino-n-propylamine and 2(diethylamino)ethylamine; and poly(alkylene oxide) residues having at least one reactive hydroxyl group, such as poly(ethylene oxide) monoethyl ether, poly(ethylene oxide) monoethyl ether, polytethylene oxide-propylene oxide) monomethyl ether and poly(ethylene oxide-propylene oxide) monoethyl ether. These segments (A^{x}, A^{y}) that become hydrophilic may be of one type alone or may be used in a combination of two or more types. Use as a copolymerized mixed compound is also possible.

### (8) Acetoacetyl Group-Bearing Compounds

Examples of acetoacetyl group-bearing compounds include allyl acetoacetate, vinyl acetoacetate, 2-(acetoacetoxy)ethyl acrylate, 2-(acetoacetoxy)ethyl methacrylate, 2-(acetoacetoxyl)propyl acrylate and 2-(acetoacetoxy)propyl methacrylate. These may be used singly or as combinations of two or more thereof.

### (9) Carboxyl Group-Bearing Compounds

The carboxyl group-bearing compounds are not subject to any particular limitation. Examples include various unsaturated mono- or dicarboxylic acid compounds or unsaturated dibasic acid compounds, such as acrylic acid, methacrylic acid, crotonic aid, itaconic acid, maleic acid, fumaric acid, monobutyl itaconate and monobutyl maleate. These may be used singly or as.combinations of two or more thereof.

### (10) Carbonyl Group-Bearing Compounds

Exemplary carbonyl group-bearing compounds include compounds having a t-butyloxycarbonyl group,

a 1,1-dimethylpropyloxycarbonyl group,

a 1-methyl-1-ethylpropyloxycarbonyl group,

a 1,1-diethylpropyloxycarbonyl group,

a 1,1-dimethylbutyloxycarbonyl group,

a 1,1-diethylbutyloxycarbonyl group,

a 1,1-dipropylbutyloxycarbonyl group,

a 1-methyl-1-ethylbutyloxycarbonyl group,

a 1-methyl-1-propylbutyloxycarbonyl group,

a 1-ethyl-1-propylbutyloxycarbonyl group,

a 1-phenylethyloxycarbonyl group,

a 1-methyl-1-phenylethyloxycarbonyl group,

a 1-phenylpropyloxycarbonyl group,

a 1-methyl-1-phenylpropyloxycarbonyl group,

a 1-ethyl-1-phenylpropyloxycarbonyl group,

a 1-phenylbutyloxycarbonyl group,

a 1-methyl-1-phenylbutyloxycarbonyl group,

a 1-ethyl-1-phenylbutyloxycarbonyl group,

a 1-propyl-1-phenylbutyloxycarbonyl group,

a 1-(4-methylphenyl)ethyloxycarbonyl group,

a 1-methyl-1-(4-methyl)phenylethyloxycarbonyl group,

a 1-(4-methylphenyl)propyloxycarbonyl group,

a 1-methyl-1-(4-methylphenyl)propyloxycarbonyl group,

a 1-ethyl-1-(4-methylphenyl)propyloxycarbonyl group,

a 1-(4-methylphenyl)butyloxycarbonyl group,

a 1-methyl-1-(4-methylphenyl)butyloxycarbonyl group,

a 1-ethyl-1-(4-methylphenyl)butyloxycarbonyl group,

a 1-propyl-1-(4-methylphenyl)butyloxycarbonyl group,

a 1-cyclopentylethyloxycarbonyl group,

a 1-methyl-1-cyclopentylethyloxycarbonyl group,

a 1-cyclopentylpropyloxycarbonyl group,

a 1-methyl-1-cyclopentylpropyloxycarbonyl group,

a 1-ethyl-1-cyclopentylpropyloxycarbonyl group,

a 1-cyclopentylbutyloxycarbonyl group,

a 1-methyl-1-cyclopentylbutyloxycarbonyl group,

a 1-ethyl-1-cyclopentylbutyloxycarbonyl group,

a 1-propyl-1-cyclopentylbutyloxycarbonyl group,

a 1-cyclohexylethyloxycarbonyl group,

a 1-methyl-1-cyclohexylethyloxycarbonyl group,

a 1-cyclohexylpropyloxycarbonyl group,

a 1-methyl-1-cyclohexylpropyloxycarbonyl group,

a 1-ethyl-1-cyclohexylpropyloxycarbonyl group,

a 1-cyclohexylbutyloxycarbonyl group,

a 1-methyl-1-cyclohexylbutyloxycarbonyl group,

a 1-ethyl-1-cyclohexylbutyloxycarbonyl group,

a 1-propyl-1-cyclohexylbutyloxycarbonyl group,

a 1-(4-methylcyclohexyl)ethyloxycarbonyl group,

a 1-methyl-1-(4-methylcyclohexyl)ethyloxycarbonyl group,

a 1-(4-methylcyclohexyl)propyloxycarbonyl group,

a 1-methyl-1-(4-methylcyclohexyl)propyloxycarbonyl group,

a 1-ethyl-1-(4-methylcyclohexyl)propyloxycarbonyl group,

a 1-(4-methylcyclohexyl)butyloxycarbonyl group,

a 1-methyl-1-(4-methylcyclohexyl)butyloxycarbonyl group,

a 1-ethyl-1-(4-methylcyclohexyl)butyloxycarbonyl group,

a 1-propyl-1-(4-methylcyclohexyl)butyloxycarbonyl group,

a 1-(2,4-dimethylcyclohexyl)ethyloxycarbonyl group,

a 1-methyl-1-(2,4-dimethylcyclohexyl)ethyloxycarbonyl group,

a 1-(2,4-dimethylcyclohexyl)propyloxycarbonyl group,

a 1-methyl-1-(2,4-dimethylcyclohexyl)propyloxycarbonyl group,

a 1-ethyl-1-(2,4-dimethylcyclohexyl)propyloxycarbonyl group,

a 1-(2,4-dimethylcyclohexyl)butyloxycarbonyl group,

a 1-methyl-1-(2,4-dimethylcyclohexyl)butyloxycarbonyl group,

a 1-ethyl-1-(2,4-dimethylcyclohexyl)butyloxycarbonyl group,

a 1-propyl-1-(2,4-dimethylcyclohexyl)butyloxycarbonyl group,

a cyclopentyloxycarbonyl group,

a 1-methylcyclopentyloxycarbonyl group,

a 1-ethylcyclopentyloxycarbonyl group,

a 1-propylcyclopentyloxycarbonyl group,

a 1-butylcyclopentyloxycarbonyl group,

a cyclohexyloxycarbonyl group,

a 1-methylcyclohexyloxycarbonyl group,

a 1-ethylcyclohexyloxycarbonyl group,

a 1-propylcyclohexyloxycarbonyl group,

a 1-butylcyclohexyloxycarbonyl group,

a 1-pentylcyclohexyloxycarbonyl group,

a 1-methylcycloheptyloxycarbonyl group or

a 1-methylcyclooctyloxycarbonyl group. Specific examples of carbonyl group-bearing compounds include ketones such as acetone, methyl ethyl ketone and acetophenone; and esters such as ethyl acetate, butyl acetate, methyl propionate, ethyl acrylate and butyrolactone. These may be used singly or as combinations of two or more thereof.

### (11) Hydroxyl Group-Bearing Compounds

Examples of hydroxyl group-bearing compounds include hydroxyl group-bearing (meth)acrylic monomers such as 2-hydroxyethyl (meth)acrylate, 2-hydroxypropyl (meth)acrylate, 3-hydroxypropyl (meth)acrylate and 4-hydroxybutyl (meth)acrylate; polyalkylene glycol (meth)acrylic compounds such as polyethylene glycol mono(meth)acrylate and polypropylene glycol mono(meth)acrylate; hydroxyalkyl vinyl ether compounds such as hydroxyethyl vinyl ether and hydroxybutyl vinyl ether; and hydroxyl group-bearing allyl compounds such as allyl alcohol and 2-hydroxyethyl allyl ether. These may be used singly or as combinations of two or more thereof.

In addition, hydroxyl group-bearing polymers such as fully or partially saponified resins of polyvinyl alcohols (PVA), and saponified resins of acetic acid ester-containing polymers composed of a copolymer of vinyl acetate with another vinyl monomer may also be used as hydroxyl group-bearing compounds.

### (12) Amino Group-Bearing Compounds

Examples of amino group-bearing compounds include the amino group-bearing alkyl ester derivatives of acrylic acid or methacrylic acid, such as aminoethyl acrylate, N-propylaminoethyl acrylate, N-ethylaminopropyl methacrylate, N-phenylaminoethyl methacrylate, and N-cyclohexylaminoethyl methacrylate; allylamine derivatives such as allylamine and N-methylallylamine; amino group-bearing styrene derivatives such as p-aminostyrene; and triazine derivatives such as 2-vinyl-4,6-diamino-S-triazine. Of these, compounds having a primary or secondary amino group are preferred. The foregoing compounds may be used singly or as combinations of two or more thereof.

### (13) Aldehyde Group-Bearing Compounds

Examples of aldehyde group-bearing compounds include (meth)acrolein. These may be used singly or as combinations of two or more thereof.

### (14) Mercapto Group-Bearing Compounds

Examples of mercapto group-bearing compounds include (i) aliphatic alkyl monofunctional thiols such as methanethiol, ethanethiol, n- and iso-propanethiol, n- and iso-butanethiol, pentanethiol, hexanethiol, heptanethiol, octanethiol, nonanethiol, decanethiol and cyclohexanethiol; (ii) heterocycle-containing aliphatic thiols such as 1,4-dithian-2-thiol, 2-(1-mercaptomethyl)-1,4-dithian, 2-(1-mercaptoethyl)-1,4-dithian, 2-(1-mercaptopropyl)-1,4-dithian, 2-(mercaptobutyl)-1,4-dithian, tetrahydrothiophen-2-thiol, tetrahydrothiophen-3-thiol, pyrrolidine-2-thiol, pyrrolidine-3-thiol, tetrahydrofuran-2-thiol, tetrahydrofuran-3-thiol, piperidine-2-thiol, piperidine-3-thiol and piperidine-4-thiol; (iii) aliphatic thiols such as 2-mercaptoethanol, 3-mercaptopropanol and thioglycerol; (iv) unsaturated double bond-containing compounds such as 2-mercaptoethyl (meth)acrylate, 2-mercapto-1-carboxyethyl (meth)acrylate, N-(2-mercaptoethyl) acrylamide, N-(2-mercapto-1-carboxyethyl) acrylamide, N-(2-mercaptoethyl) methacrylamide, N-(4-mercaptophenyl) acrylamide, N-(7-mercaptonaphthyl) acrylamide and mono 2-mercaptoethylamide maleate; (v) aliphatic dithiols such as 1,2-ethanedithiol, 1,3-propanedithiol, 1,4-butanedithiol, 1,6-hexanedithiol, 1,8-octanedithiol, 1,2-cyclohexanedithiol, ethylene glycol bisthioglycolate, ethylene glycol bisthiopropionate, butanediol bisthioglycolate, butanediol bisthiopropionate, trimethylolpropane tristhioglycolate, trimethylolpropane tristhiopropionate, pentaerythritol tetrakisthioglycolate, pentaerythritol tetrakisthiopropionate, tris(2-mercaptoethyl) isocyanurate and tris(3-mercaptopropyl) isocyanurate; (vi) aromatic dithiols such as 1,2-benzenedithiol, 1,4-benzenedithiol, 4-methyl-1,2-benzenedithiol, 4-butyl-1,2-benzenedithiol and 4-chloro-1,2-benzenedithiol; and (vii) mercapto group-bearing polymers such as modified polyvinyl alcohols containing mercapto groups. These compounds may be used singly or as combinations of two or more thereof.

### (15) Sulfonic Acid Group-Bearing Compounds

Examples of sulfonic acid group-bearing compounds include alkenesulfonic acids such as ethylenesulfonic acid, vinylsulfonic acid and (meth)allylsulfonic acid; aromatic sulfonic acids such as styrenesulfonic acid and α-methylstyrenesulfonic acid; C₁₋₁₀ alkyl (meth)allylsulfosuccinic acid esters; sulfo-C₂₋₆ alkyl (meth)acrylates such as sulfopropyl (meth)acrylate; and sulfonic acid group-bearing unsaturated esters such as methyl vinyl sulfonate, 2-hydroxy-3-(meth)acryloxypropylsulfonic acid, 2-(meth)acryloylamino-2,2-dimethylethanesulfonic acid, 3-(meth)acryloyloxyethanesulfonic acid, 3-(meth)acryloyloxy-2-hydroxypropanesulfonic acid, 2-(meth)acrylamido-2-methylpropanesulfonic acid and 3-(meth)acrylamido-2-hydroxypropanesulfonic acid, and salts thereof. These may be used singly or as combinations of two or more thereof.

Any of various suitable known methods may be used without particular limitation to introduce the above functional groups.

If the particle is an organic particle, organic particles having a desired functional group on the surface may be obtained by, for example, polymerizing (such as through bulk, emulsion, suspension or dispersion polymerization) a polymerizable monomer bearing the desired functional group so as to directly produce spherical particles, or by suitably grinding a similarly produced polymer.

Alternatively, organic particles having the desired functional groups on their surface may be obtained by covering the surfaces of prefabricated organic core particles with a functional group-containing compound or a functional group-containing polymeric compound obtained by the polymerization thereof.

The organic core particle is not subject to any particular limitation, provided it is insoluble in the reaction solvent. For example, use may be made of fine particles of any of the above-mentioned synthetic resins or fine particles of a natural polymer. The organic core particles in this case may be treated with the above-mentioned surface treatment agent.

In cases where a plurality of different functional groups are to be introduced, polyfunctional particles having a plurality of the above-mentioned types of functional groups may be obtained by the concomitant use of monomers bearing the respective reactive groups mentioned above to form a multifunctional copolymer, and by controlling the reaction conditions, such as the amounts of the monomers added and the reaction temperature.

If both the (A) particle and the (B) particle are resin particles made of organic polymers, the average molecular weight of each polymer, while not subject to any particular limitation, will generally be a weight-average molecular weight of from about 1,000 to about 3,000,000. The weight-average molecular weight is a measured value obtained by gel permeation chromatography.

If the particle is an inorganic particle, inorganic particles having a desired functional group on the surface may be obtained by surface treatment with an above-mentioned functional group-bearing compound capable of forming a chemical bond with a functional group (e.g., a hydroxyl group) present on the surface of the inorganic particles, or by subjecting inorganic particles that have been treated with a surface treatment agent to additional surface treatment with a compound having the desired functional group.

Alternatively, the surface of an inorganic particle or a surface-treated inorganic particle may be covered with a functional group-containing polymeric compound to give an inorganic-organic composite particle having the desired functional group.

No particular limitation is imposed on the method used to cover the surface of the organic core particle and the inorganic particle with a functional group-containing polymeric compound layer. Exemplary methods include techniques involving the use of a spray dryer, seed polymerization, adsorption of the functional group-containing polymeric compound onto the particle, and a graft polymerization process that chemically bonds the functional group-containing polymeric compound with the particle. Of these, the use of graft polymerization is preferred for the following reasons: (1) the ability to form a polymer layer which is relatively thick and does not readily dissolve out even during long-term dispersion in a solvent, (2) the ability to confer diverse functional groups and thus impart various surface properties by changing the type of monomer, and (3) grafting at a high density is possible by carrying out polymerization based on polymerization initiating groups introduced onto the surface of the particles.

The method of forming a functional group-containing polymeric compound layer by means of grafted chains is exemplified here by a process in which the grafted chains are prepared beforehand by graft polymerization, then are chemically bonded to the surface of the particle; and a process in which graft polymerization is carried out at the surface of the particle. Although either method may be used, to increase the density of the grafted chains at the surface of the particle, the latter approach, which is less subject to adverse effects such as steric hindrance, is preferred.

Examples of the chemical bonds between the organic core particle and the inorganic particle include covalent bonds, hydrogen bonds, and coordinate bonds.

The reaction in which functional groups are introduced to obtain particle (A) or particle (B) is preferably carried out in the presence of a solvent. By carrying out the reaction in the presence of a solvent, (A) particles or (B) particles in which functional groups have been uniformly introduced on the surface can be obtained in a monodispersed state without a loss of physical properties from the application of excess impact forces to the core particles (organic particles or inorganic particles) used as the starting material or to the particles obtained by the reaction.

The reaction conditions when introducing the functional groups depend on such factors as the type of functional group inserting reaction, the types of starting materials to be used, the type of functional group to be introduced, the type of functional group-containing compound, the particle concentration and the particle specific gravity, and thus cannot be strictly specified. However, the reaction temperature is typically in a range of from 10 to 200° C., preferably from 30 to 130° C., and more preferably from 40 to 90° C. During the reaction, it is desirable to stir the system at a rate capable of uniformly dispersing the particles.

The reaction solvent is not subject to any particular limitation, and may be selected from among general solvents that are suitable for the particular starting materials used in the reaction. Illustrative examples of reaction solvents that may be used include water; alcohols such as methanol, ethanol, 1-propanol, 2-propanol, 1-butanol, 2-butanol, isobutyl alcohol, tert-butyl alcohol, 1-pentanol, 2-pentanol, 3-pentanol, 2-methyl-1-butanol, isopentyl alcohol, tert-pentyl alcohol, 1-hexanol, 2-methyl-1-pentanol, 4-methyl-2-pentanol, 2-ethylbutanol, 1-heptanol, 2-heptanol, 3-heptanol, 2-octanol, 2-ethyl-1-hexanol, benzyl alcohol and cyclohexanol; ether alcohols such as methyl cellosolve, ethyl cellosolve, isopropyl cellosolve, butyl cellosolve and diethylene glycol monobutyl ether; ketones such as acetone, methyl ethyl ketone, methyl isobutyl ketone and cyclohexanone; esters such as ethyl acetate, butyl acetate, ethyl propionate and cellosolve acetate; aliphatic or aromatic hydrocarbons such as pentane, 2-methylbutane, n-hexane, cyclohexane, 2-methylpentane, 2,2-dimethylbutane, 2,3-dimethylbutane, heptane, n-octane, isooctane, 2,2,3-trimethylpentane, decane, nonane, cyclopentane, methylcyclopentane, methylcyclohexane, ethylcyclohexane, p-menthane, dicyclohexyl, benzene, toluene, xylene and ethylbenzene; halogenated hydrocarbons such as carbon tetrachloride, trichloroethylene, chlorobenzene and tetrabromoethane; ethers such as ethyl ether, dimethyl ether, trioxane and tetrahydrofuran; acetals such as methylal and diethylacetal; aliphatic acids such as formic acid, acetic acid and propionic acid; and sulfur or nitrogen-bearing organic compounds such as nitropropene, nitrobenzene, dimethylamine, monoethanolamine, pyridine, dimethylformamide, dimethylsulfoxide and acetonitrile. Any one or combinations of two or more thereof may be used.

When producing the (A) particles and the (B) particles, depending on the intended application, use may be made of a suitable crosslinking agent.

Exemplary crosslinking agents include polyfunctional organic compounds having such groups as vinyl, aziridine, oxazoline, epoxy, thioepoxy, amide, isocyanate, carbodiimide, acetoacetyl, carboxyl, carbonyl, hydroxyl, amino, aldehyde, mercapto and sulfonic acid groups. Some illustrative examples include divinylbenzene; divinylbiphenyl; divinylnaphthalene; (poly)alkylene glycol di(meth)acrylates such as (poly)ethylene glycol di(meth)acrylate, (poly)propylene glycol di(meth)acrylate and (poly)tetramethylene glycol di(meth)acrylate; alkanediol di(meth)acrylates such as 1,6-hexanediol di(meth)acrylate, 1,8-octanediol di(meth)acrylate, 1,9-nonanediol di(meth)acrylate, 1,10-decanediol di(meth)acrylate, 1,12-dodecanediol di(meth)acrylate, 3-methyl-1,5-pentanediol di(meth)acrylate, 2,4-diethyl-1,5-pentanediol di(meth)acrylate, butylethylpropanediol di(meth)acrylate, 3-methyl-1,7-octanediol di(meth)acrylate and 2-methyl-1,8-octanediol di(meth)acrylate; neopentyl glycol di(meth)acrylate, trimethylolpropane tri(meth)acrylate, tetramethylolmethane tri(meth)acrylate, tetramethylolpropane tetra(meth)acrylate, pentaerythritol tri(meth)acrylate, ethoxylated cyclohexanedimethanol di(meth)acrylate, ethoxylated bisphenol A di(meth)acrylate, tricyclodecanedimethanol di(meth)acrylate, propoxylated ethoxylated bisphenol A di(meth)acrylate, 1,1,1-tris(hydroxymethylethane) di(meth)acrylate, 1,1,1-tris(hydroxymethylethane) tri(meth)acrylate, 1,1,1-tris(hydroxymethylpropane) triacrylate, diallyl phthalate and isomers thereof, and triallyl isocyanurate and derivatives thereof. These may be used singly or as combinations of two or more thereof.

Of these vinyl group-bearing compounds, by using at least one type of compound (monomer) selected from among polyfunctional vinyl group-bearing compounds such as divinyl compounds and di(meth)acrylate compounds, particles can be obtained which have excellent mechanical properties, including a high percent recovery from compressive deformation.

In particular, for applications requiring compressive elasticity, the use of compounds which include a C₆₋₁₈ alkanediol di(meth)acrylate is preferred.

Although there will be some variation depending on the size of the (B) particles and the amount of (B) particles that adhere to the surface of (A) particles, because it is anticipated that a certain degree of loading will be applied between the (A) particles and the (B) particles when the inventive rough particles for plating or vapor deposition treatment are subjected to plating treatment or the like, it is desirable for the (A) particles and the (B) particles to be strongly bonded together. In view of this, although the functional groups may be introduced onto the surfaces of the (A) particles and the (B) particles in any of various ways, it is preferable for the functional group-containing polymeric compound to be grafted from the surface of at least the (A) particles or the (B) particles.

In such a case, it is desirable for the functional group-containing polymeric compound which is grafted to satisfy at least one of the following conditions (1) to (3).

(1) The functional group-containing polymeric compound has a number-average molecular weight of from 1,000 to 100,000.

(2) The functional group-containing polymeric compound has an average of at least two functional groups per molecule.

(3) The functional group-containing polymeric compound has a functional group equivalent weight of from 50 to 2,500.

The molecular weight of these polymeric compounds is generally from about 100 to about 1,000,000. However, for use in the present invention, the number-average molecular weight is preferably about 500 to about 500,000, and more preferably from about 1,000 to about 100,000. At a number-average molecular weight above 500,000, the viscosity in the solvent becomes too high, which may have an adverse effect on the monodispersed particles. On the other hand, at a molecular weight below 500, although the addition of protrusions is possible, the bond strength is weak, which may result in the loss of protrusions and other undesirable effects during plating treatment. The number-average molecular weight is a measured value obtained by gel permeation chromatography (GPC).

At an average number of functional groups per molecule of less than two, it may not be possible to achieve a bond strength sufficient to withstand plating treatment. It is desirable for the average number of functional groups to be preferably at least 3, more preferably at least 4, and even more preferably at least 5.

At a functional group equivalent weight of less than 50, depending on the type of functional group, self-crosslinking may occur, which may compromise the bond strength of the (B) particles. On the other hand, at a functional group equivalent weight of more than 2,500, although the addition of protrusions is possible, the bond strength weakens, which may lead to the loss of protrusions and other undesirable effects during plating treatment. The functional group equivalent weight is preferably from 80 to 1,500, more preferably from 100 to 1,000, and even more preferably from 130 to 180.

“Equivalent weight” refers to a fixed quantity assigned to each compound based on the quantitative relationship among the substances in the chemical reaction. For example, in this invention, it expresses the chemical formula weight of one molecule (in the case of a polymer, the average weight) per mole of reactive functional groups.

The functional group-containing polymeric compounds may be any selected in a combination that enables chemical bonding to take place between the functional groups on the (A) particles and the functional groups on the (B) particles, and are not subject to any particular limitation. Suitable examples include any of the above-mentioned functional group-containing compounds (those that are polymerizable) which have been homopolymerized or copolymerized with another polymerizable monomer.

Examples of polymerizable monomers which can be copolymerized with the functional group-containing compound include (i) styrenic compounds such as styrene, o-methylstyrene, m-methylstyrene, p-methylstyrene, a-methylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-phenylstyrene, p-chlorostyrene, and 3,4-dichlorostyrene; (ii) (meth)acrylate esters such as methyl acrylate, ethyl acrylate, n-butyl acrylate, isobutyl acrylate, propyl acrylate, hexyl acrylate, 2-ethylhexyl acrylate, n-octyl acrylate, dodecyl acrylate, lauryl acrylate, stearyl acrylate, 2-chloroethyl acrylate, phenyl acrylate, methyl α-chloroacrylate, methyl methacrylate, ethyl methacrylate, n-butyl methacrylate, isobutyl methacrylate, propyl methacrylate, hexyl methacrylate, 2-ethylhexyl methacrylate, n-octyl methacrylate, dodecyl methacrylate, lauryl methacrylate and stearyl methacrylate; (iii) vinyl esters such as vinyl acetate, vinyl propionate, vinyl benzoate and vinyl butyrate; (iv) (meth)acrylic acid derivatives such as acrylonitrile and methacrylonitrile; (v) vinyl ethers such as vinyl methyl ether, vinyl ethyl ether and vinyl isobutyl ether; (vi) vinyl ketones such as vinyl methyl ketone, vinyl hexyl ketone and methyl isopropenyl ketone; (vii) N-vinyl compounds such as N-vinylpyrrole, N-vinylcarbazole, N-vinylindole and N-vinylpyrrolidone; and (viii) vinyl fluoride, vinylidene fluoride, tetrafluoroethylene and hexafluoropropylene, and fluoroalkyl group-bearing (meth)acrylate esters such as trifluoroethyl acrylate and tetrafluoropropyl acrylate. These may be used singly or as combinations of two or more thereof.

Preferred examples of the foregoing functional group-containing compounds (those that are polymerizable) and, where necessary, functional group-containing polymeric compounds (resins) obtained by polymerizing the above polymerizable monomers include styrene resins, acrylic resins, methacrylic resins, polyethylene resins, polypropylene resins, silicone resins, polyester resins, polyurethane resins, polyamide resins, epoxy resins, polyvinyl butyral resins, rosins, terpene resins, phenolic resins, melamine resins, guanamine resins, oxazoline resins and carbodiimide resins. These may be used singly or as combinations of two or more thereof.

Examples of graft polymerization reactions include addition polymerization reactions such as free-radical polymerization, ionic polymerization, oxidative anionic polymerization and ring-opening polymerization; polycondensation reactions such as elimination polymerization, dehydrogenation polymerization, and denitrogenation polymerization; hydrogen transfer polymerization reactions such as polyaddition, isomerization polymerization, and group transfer polymerization; and addition condensation. Of these, free-radical polymerization is especially preferred because it is simple and highly cost-effective, and is commonly used for the industrial synthesis of various polymers. Where there is a need to control the molecular weight of the grafted chains, the molecular weight distribution or the grafting density, use can be made of living radical polymerization.

Living radical polymerization is broadly divided into three types, any of which may be used in the present invention: (i) a dissociation-bonding mechanism in which polymerization proceeds by activation involving the use of typically heat or light to reversibly cleave the covalent bond on a dormant species P-X so that it dissociates to a P radical and an X radical; (ii) atom transfer radical polymerization (ATRP), which proceeds by the activation of P-X under the action of a transition metal complex; and (iii) an exchange chain transfer mechanism in which polymerization proceeds by P-X triggering an exchange reaction with another radical.

The graft polymerization conditions are not subject to any particular limitation. Various known conditions may be employed, depending on such considerations as the monomer to be used.

For example, when grafting is effected by carrying out free radical polymerization at the surface of the organic polymer particle or the inorganic particle serving as the core, the quantity of monomer having the first or the second functional group which can be reacted therewith per 0.1 mole of reactive functional groups introduced onto the core particle (or originally present thereon) is generally from 1 to 300 moles, and the quantity of polymerization initiator used is generally from 0.005 to 30 moles. The polymerization temperature is generally from −20 to 200° C., and the polymerization time is generally from 0.2 to 72 hours.

The functional group-containing polymeric compound layer formed by graft polymerization, aside from being formed as described above by carrying out a polymerization reaction at the surface of the core particles, may alternatively be formed, as noted earlier, by reacting an already prepared functional group-bearing polymeric compound with reactive functional groups on the surface of the particles. In such a case, the proportions in which the functional group-bearing polymeric compound and the core particles are mixed, while not subject to any particular limitation, are typically such that the amount of the functional group-bearing polymeric compound added, expressed as an equivalent ratio with respect to the reactive functional groups on the core particle, is in a range of about 0.3 to 30, preferably 0.8 to 20, and more preferably 1 to 10.

Although it is possible to produce (A) particles and (B) particles having a functional group-containing polymeric compound at the surface even when the amount of functional group-containing polymeric compound added exceeds an equivalent ratio of 30, this is often undesirable for production because of the increased amount of residual unreacted polymeric compound. On the other hand, at an equivalent ratio of less than 0.3, adherence by the protrusions on the rough particle obtained using the resulting (A) particles (or (B) particles) may decrease.

Illustrative examples of methods that may be used to react the particle with the polymer include dehydration reactions, nucleophilic substitution reactions, electrophilic substitution reactions, electrophilic addition reactions, and adsorption reactions.

Polymerization initiators that may be used in radical polymerization are not subject to any particular limitation, and may be suitably selected from among known radical polymerization initiators. Illustrative examples include benzoyl peroxide, cumene hydroperoxide, t-butyl hydroperoxide, persulfates such as sodium persulfate and ammonium persulfate, and azo compounds such as azobisisobutyronitrile, azobismethylbutyronitrile and azobisisovaleronitrile. These may be used singly or as combinations of any two or more thereof.

The polymerization solvent used may be one that is suitably selected from among the various solvents mentioned above based on such considerations as the target particles and the starting monomers to be used.

When the (A) particles and (B) particles are produced by polymerization reactions, depending on the polymerization process used, known (polymer) dispersants, stabilizers, emulsifying agents, surfactants, catalysts (reaction accelerators) and the like which are commonly employed in polymer synthesis may be included as appropriate.

Next, the method of producing the rough particles is described.

The method of producing the inventive rough particles for plating or vapor deposition treatment is not subject to any particular limitation, provided it is a method capable of forming rough particles by chemically bonded the above-described first functional groups present on the surface of the (A) particles and second functional groups present on the surface of the (B) particles. However, a method that involves mixing together the (A) particles and the (B) particles in the presence of a dispersing medium is preferred. Treatment in this way enables the (A) particles and the (B) particles to be united in such a way that the resulting asperities are uniformly or randomly spaced, without applying to the particles excessive impact forces that could be detrimental to their physical properties.

The dispersion medium is not subject to any particular limitation, provided it does not dissolve the (A) particles and the (B) particles. Any of the reaction solvents mentioned above may be suitably selected and used for this purpose.

When either or both of the (A) particles and the (B) particles are particles having a functional group-containing polymeric compound grafted from the surface thereof, it is preferable to use a solvent in which the grafted polymeric compound is soluble. By using such a solvent, the bonding regions on the (A) particles and the (B) particles are increased, enabling the bonds between the respective particles to be made more secure.

When both the (A) particles and the (B) particles are particles having functional group-containing polymeric compounds grafted from their surfaces, the bonds between the respective particles can be made yet even stronger.

Treatment in this way enables the functional groups in the polymeric compounds to be used to the fullest possible degree. That is, the number of reaction sites increases, creating a larger bonding surface area. This not only enables the bonds between the (A) particles and the (B) particles to be made more secure, it also increases the surface area of contact between the polymeric compounds, so that adhesive forces particular to the polymeric compounds also come into play, resulting in the formation of even stronger bonds.

Moreover, the dispersibility of the (A) and (B) particles in the solvent also rises, causing the settling rate of the particles to change, and thus facilitating the formation of asperities.

Based on such considerations as the materials making up the (A) particles and the (B) particles and the types of the first and second functional group-containing polymeric compounds, any reaction solvent from among those listed above may be suitably selected and used. However, from the standpoint of the solubility of the first and second functional group-containing polymeric compounds, it is especially preferable to use a reaction solvent in 100 g of which (in the case of a solvent mixture, 100 g of the overall solvent mixture) at least 0.01 g, preferably at least 0.05 g, more preferably at least 0.1 g, even more preferably at least 1 g, and most preferably at least 2 g, of each of the polymeric compounds will dissolve.

Preferred examples of the solvent include water; alcohols such as methanol, ethanol and 2-propanol; ether alcohols such as methyl cellosolve, ethyl cellosolve, isopropyl cellosolve, butyl cellosolve and diethylene glycol monobutyl ether; and water-soluble organic solvents such as acetone, tetrahydrofuran, acetonitrile and dimethylformamide; as well as solvent mixtures thereof.

The reaction conditions vary depending on such factors as the types of the first and second functional groups, the particle concentration and the particle specific gravities, and thus cannot be strictly specified. Even so, the reaction temperature is typically in a range of from 10 to 200° C., preferably 30 to 130° C., and more preferably 40 to 90° C. The reaction time when the reaction is carried out between 40 and 90° C. is typically about 2 to 48 hours, and preferably about 8 to 24 hours.

Rough particles can be obtained even when the reaction is carried out for a long time exceeding 48 hours, although carrying out the reaction under conditions requiring a long period of time is not desirable from the standpoint of production efficiency.

The solution concentration at the time of the bonding reaction, as calculated by the following formula, is typically from 1 to 60 wt %, preferably 5 to 40 wt %, and more preferably 10 to 30 wt %.

Solution concentration (wt %)=[(weight of (A) particles+weight of (B) particles)/total weight of solution]×100

Here, at a solution concentration above 60 wt %, the amount of (A) particles or (B) particles is too high, as a result of which the balance within the solution may collapse, making it difficult to obtain monodispersed rough particles. On the other hand, at a solution concentration below 1 wt %, rough particles can be obtained, but this is not desirable as it may make it necessary to carry out the reaction over an extended period of time or otherwise invite a decline in productivity.

In the production of the rough particles, it is important to adjust the conditions so that, at the very least, the (A) particles are not uniformly covered by (B) particles. When such uniformly covered rough particles are subjected to plating treatment or the like, as the thickness of the conductive film increases, the degree of roughness owing to the (B) particles decreases and ultimately vanishes, as a result of which a high electrical conductivity may not be attainable in the conductive rough particles.

By suitably adjusting such factors as the amounts in which the (A) particles and the (B) particles are added, the reaction temperature, the reaction time and the type of polymerization solvent, it is possible to vary the diameter of the protrusions formed by the (B) particles and the spacing of the protrusions. To obtain rough particles in which the (A) particle is not uniformly covered by (B) particles and which have thereon suitably spaced protrusions, although the sizes and specific gravities of the (A) particles and the (B) particles also exert a strong influence, assuming the particle size ratio between the (A) particles and the (B) particles to be in accordance with the invention, mixing treatment may be carried out by setting the amount of (B) particles added with respect to the (A) particles to generally from 0.01 to 50 wt %, preferably from 0.1 to 20 wt %, and more preferably from 1.0 to 15 wt %.

During production of the rough particles, known dispersants, antioxidants, stabilizers, emulsifying agents, catalysts and the like may be suitably included within the reaction system in an amount of from 0.01 to 50 wt % of the reaction solution.

Illustrative examples of dispersants and stabilizers that may be used include polystyrene derivatives such as polyhydroxystyrene, polystyrene sulfonic acid, vinylphenol-(meth)acrylate copolymers, styrene-(meth)acrylate copolymers and styrene-vinylphenol-(meth)acrylate copolymers; poly(meth)acrylic acid derivatives such as poly(meth)acrylic acid, poly(meth)acrylamide, polyacrylonitrile, poly(ethyl (meth)acrylate) and poly(butyl (meth)acrylate); polyvinyl alkyl ether derivatives such as polymethyl vinyl ether, polyethyl vinyl ether, polybutyl vinyl ether and polyisobutyl vinyl ether; cellulose and cellulose derivatives such as methyl cellulose, cellulose acetate, cellulose nitrate, hydroxymethyl cellulose, hydroxyethyl cellulose, hydroxypropyl cellulose and carboxymethyl cellulose; polyvinyl acetate derivatives such as polyvinyl alcohol, polyvinyl butyral, polyvinyl formal and polyvinyl acetate; nitrogen-containing polymer derivatives such as polyvinyl pyridine, polyvinyl pyrrolidone, polyethyleneimine and poly(2-methyl-2-oxazoline); polyvinyl halide derivatives such as polyvinyl chloride and polyvinylidene chloride; and polysiloxane derivatives such as polydimethylsiloxane. These may be used singly or as combinations of two or more thereof.

Illustrative examples of emulsifying agents (surfactants) include anionic emulsifying agents such as alkyl sulfates (e.g., sodium laurylsulfate), alkylbenzene sulfonates (e.g., sodium dodecylbenzene sulfonate), alkylnaphthalene sulfonates, fatty acid salts, alkyl phosphates and alkyl sulfosuccinates; cationic emulsifying agents such as alkylamine salts, quaternary ammonium salts, alkyl betaine and amine oxides; and nonionic emulsifying agents such as polyoxyethylene alkyl ethers, polyoxyethylene alkyl ethers, polyoxyethylene alkylallyl ethers, polyoxyethylene alkylphenyl ethers, sorbitan fatty acid esters, glycerol fatty acid esters and polyoxyethylene fatty acid esters. These may be used singly or as combinations of two or more thereof.

The electrically conductive particle obtained using the above-described rough particle for plating or vapor deposition treatment is composed of the rough particle and an electrically conductive film formed on the surface of the rough particle. At least a portion of the surface of the conductive film has asperities which correspond to the rough particle, and preferably the entire surface of the conductive film has asperities which correspond to the rough particle for plating or vapor deposition treatment.

As used herein, “asperities which correspond to the rough particle for plating or vapor deposition treatment” refers to protrusions (depressions) that reflect the protrusions (and the depressions which form as a result thereof) formed by the (B) particles (and/or agglomerates of (B) particles) bonded to the (A) particle.

The thickness of the conductive film may be suitably controlled on the basis of such factors as the height difference for the asperities on the rough particle for plating or vapor deposition treatment and the electrical conductivity of the conductive rough particles, so long as the thickness is of a degree that does not bury the asperities on the rough particle for plating or vapor deposition treatment. A thickness of at least 0.1 μm is preferable for conferring a higher electrical conductivity.

The thickness of the electrically conductive film refers here to the value obtained by using an ultramicrotome (Leica Microsystems Japan) to cut a thin-film specimens having a thickness of about 100 nm from a small amount of resin-embedded conductive rough particles, photographing the specimen at a measurable enlargement (2,000 to 200,000×) under a scanning transmission electron microscope (S-4800, manufactured by Hitachi High Technologies Corporation; abbreviated below as “STEM”), measuring (n=50) the thickness of the plating layer on particles in the cross-sectional image, and taking the average of the measured values.

The metal material making up the electrically conductive film is not subject to any particular limitation. Examples of such materials that may be used include copper, nickel, cobalt, palladium, gold, platinum rhodium, silver, zinc, iron, lead, tin, aluminum, indium, chromium, antimony, bismuth, germanium, cadmium and silicon.

Examples of methods that may be used to form the electrically conductive film include known plating processes and discharge coating processes such as vapor deposition. However, from the standpoint of the particle dispersibility and the uniformity of the electrically conductive film thickness, an electroless plating process is preferred.

Electroless plated rough particles can be obtained by, for example, adding and thoroughly dispersing a complexing agent to an aqueous slurry of the rough particles that has been prepared using a known technique and apparatus, then adding a chemical solution as the metal electroless plating solution to form a metal film.

The complexing agent employed may be suitably selected from among various known compounds that have a complexing action on the metal ions used. Illustrative examples include carboxylic acids (and their salts), such as citric acid, hydroxyacetic acid, tartaric acid, malic acid, lactic acid, gluconic acid, and alkali metal salts or ammonium salts thereof; amino acids such as glycine, amines such as ethylenediamine and alkylamine; as well as ammonium, EDTA and pyrophosphoric acid (and salts thereof).

Preferred examples of electroless plating solutions that may be used include those containing one or more metal such as copper, nickel, cobalt, palladium, golf, platinum and rhodium. The electroless plating reaction is generally carried out by adding to the metal salt an aqueous solution of a reducing agent such as sodium phosphate, hydrazine or sodium borohydride, and an aqueous solution of a pH adjuster such as sodium hydroxide. Electroless plating solutions containing metals such as copper, nickel, silver and gold are commercially available and can be inexpensively acquired.

### EXAMPLES

Synthesis examples, examples of the invention, and comparative examples are given below by way of illustration, and not by way of limitation.

In the following description, the number-average molecular weights are measured values obtained by gel filtration chromatography.

### Molecular Weight Measurement Conditions

GPC apparatus: C-R7A, manufactured by Shimadzu Corporation

Detector: UV spectrophotometer detector (SPD-6A), manufactured by Shimadzu Corporation

Pump: Molecular weight distribution measurement system pump (LC-6AD), manufactured by Shimadzu Corporation

Columns: A total of three columns connected in series; two Shodex KF804L (Showa Denko K. K.) columns and one Shodex KF806 (Showa Denko)

Solvent: Tetrahydrofuran

Measurement temperature: 40° C.

### (1) Synthesis of Core Particles

### Synthesis Example 1

The starting compounds and other ingredients shown below were mixed in the indicated proportions and the resulting mixture was added all at once to a 500 ml flask. Dissolved oxygen in the mixture was displaced with nitrogen, following which the flask contents were heated at an oil bath temperature of 80° C. for about 15 hours under stirring and a stream of nitrogen to give a carboxyl group-containing styrene copolymer particle solution.

The resulting particle solution was repeatedly washed and filtered three to five times with a water-methanol solvent mixture (weight ratio, 3:7) using a known suction filtration apparatus, then vacuum dried, yielding Core Particles 1. The particle diameter of the Core Particles 1 was examined and measured by scanning electron microscopy (SEM), whereupon the particles were found to be spherical particles having an average particle size of 3.5 μm.

| | |
|---|---|
| Styrene | 48.2 g |
| Methacrylic acid | 20.6 g |
| Methanol | 218.0 g |
| Water | 52.0 g |
| Azobis(2-methylbutyronitrile) (ABNE) | 3.0 g |
| Styrene-methacrylic copolymer resin solution | 70.0 g |
| (The styrene-methacrylic copolymer resin solution was a 40 | |
| wt % solution of styrene/2-hydroxyethyl methacrylate (= 2:8) | |
| in methanol. | |

### (The styrene-methacrylic copolymer resin solution was a 40 wt % solution of styrene/2-hydroxyethyl methacrylate (=2:8) in methanol.

### Synthesis Example 2

Aside from using the starting compounds and other ingredients shown below in the indicated proportions, Core Particles 2 were obtained in the same way as in Synthesis Example 1. The particle diameter of the Core Particles 2 was examined and measured by SEM, whereupon the particles were found to be spherical particles having an average particle size of 12.9 μm.

| | |
|---|---|
| Styrene | 48.2 g |
| Acrylic acid | 20.6 g |
| Methanol | 162.0 g |
| Ethanol | 54.0 g |
| Water | 54.0 g |
| Azobis(2-methylbutyronitrile) (ABNE) | 3.1 g |
| Styrene-methacrylic copolymer resin solution | 60.0 g |
| (The styrene-methacrylic copolymer resin solution was a 40 | |
| wt % solution of styrene/2-hydroxyethyl methacrylate (= 2:8) | |
| in methanol. | |

### (The styrene-methacrylic copolymer resin solution was a 40 wt % solution of styrene/2-hydroxyethyl methacrylate (=2:8) in methanol.

### Synthesis Example 3

Aside from using the starting compounds and other ingredients shown below in the indicated proportions and setting the oil bath temperature to 70° C., Core Particles 3 were obtained in the same way as in Synthesis Example 1. The particle diameter of the Core Particles 3 was examined and measured by SEM, whereupon the particles were found to be spherical particles having an average particle size of 0.4 μm.

| | |
|---|---|
| Styrene | 23.9 g |
| Methacrylic acid | 6.0 g |
| Methanol | 231.7 g |
| Water | 67.3 g |
| Azobis(2-methylbutyronitrile) (ABNE) | 1.2 g |
| Styrene-methacrylic copolymer resin solution | 86.3 g |
| (The styrene-methacrylic copolymer resin solution was a 40 | |
| wt % solution of styrene/2-hydroxyethyl methacrylate (= 2:8) | |
| in methanol. | |

### Synthesis Example 4

The compounds shown below were added all at once to a 1,000 ml flask. Dissolved oxygen in the mixture was displaced with nitrogen, following which the flask contents were stirred with a stirrer under heating at an oil bath temperature of 82° C. and a stream of nitrogen for about 6 hours to give a DVB/methacrylic acid/NK-ester DOD-N (Shin-Nakamura Chemical Co., Ltd.) copolymer particle solution.

| | |
|---|---|
| DVB (DVB-960) | 14.7 g |
| Methacrylic acid | 14.7 g |
| NK-ester DOD-N (Shin-Nakamura Chemical) | 19.6 g |
| (1,10-decanediol dimethacrylate) | |
| Acetonitrile | 490 g |
| Azobisisobutyronitrile (AIBN) | 4.2 g |
| n-Dodecane | 22.4 g |
| Isopropyl alcohol | 24.5 g |

The resulting particle solution was repeatedly washed and filtered three to five times with THF using a known suction filtration apparatus, then vacuum dried, yielding Core Particles 4 composed of cured ingredients. The particle diameter of the Core Particles 4 was examined and measured by SEM, whereupon the particles were found to be spherical particles having an average particle size of 4.5 μm. The coefficient of variation (CV) was 4.0%

Also, the compressive elasticity, as measured using a microcompression tester (MCT-W201, manufactured by Shimadzu Corporation), was 2,500 N, and the point of failure was 23 mN.

The term “10% K value” refers herein to the compressive elastic deformation characteristic K₁₀ of a single particle at a particle diameter displacement of 10%, and is defined by the following formula.

K₁₀=(3/√2)×(S₁₀^{-3/2})×(R^{-1/2})×F₁₀

### In the formula, F₁₀ is the load (N) required for 10% displacement of the particle, S₁₀ is the compressive deformation (mm) at 10% displacement of the particle, and R is the radius (mm) of the particle.

### Synthesis Example 5

Aside from using the starting compounds and other ingredients shown below in the indicated proportions and setting the oil bath temperature to 78° C., Core Particles 5 composed of a styrene homopolymer were obtained in the same way as in Synthesis Example 1. The particle diameter of the Core Particles 5 was examined and measured by SEM, whereupon the particles were found to be spherical particles having an average particle size of 4.4 μm.

| | |
|---|---|
| Styrene | 73.1 g |
| Methanol | 179.9 g |
| Ethanol | 39.3 g |
| Azobisisobutyronitrile (AIBN) | 3.4 g |
| Styrene-methacrylic copolymer resin solution | 63.8 g |
| (The styrene-methacrylic copolymer resin solution was a 40 | |
| wt % solution of styrene/2-hydroxyethyl methacrylate (= 2:8) | |
| in methanol. | |

### (2) Synthesis of Functional Group-Bearing (Polymeric) Organic Compounds

### Synthesis Example 6

After initially reacting 800 g of 2,6-tolylene diusocyanate (TDI) with 441.4 g of polyoxyethylene monomethyl ether having a degree of polymerization m=8 at 50° C. for 1 hour, 8 g of carbodiimidation catalyst (3-methyl-1-phenyl-2-phospholene-1-oxide) was added and the reaction was carried out at 85° C. for 6 hours under a stream of nitrogen, yielding an end-capped carbodiimide resin (average degree of polymerization=7; average molecular weight, 1,852). To this was gradually added 709.6 g of distilled water, giving a carbodiimide resin solution (resin concentration, 60 wt %). The carbodiimide equivalent weight was 265/NCN.

### Synthesis Example 7

After initially reacting 800 g of m-tetramethylxylylene diisocyanate (TMXDI) with 16 g of the above carbodiimidation catalyst at 180° C. for 26 hours, an isocyanate-terminated m-tetramethylxylylene carbodiimide resin was obtained. Next, 668.9 g of the resulting carbodiimide and 333.9 g of polyoxyethylene monomethyl ether having a degree of polymerization m=12 were reacted at 140° C. for 6 hours. To this was gradually added 668.5 g of distilled water, yielding a carbodiumide resin solution (resin concentration, 60 wt %). The carbodiimide equivalent weight was 336/NCN (average degree of polymerization=10; number-average molecular weight, 3,364).

### (3) Synthesis of (A) and (B) Particles

### Synthesis Example 8

The starting compounds and other ingredients shown below were mixed in the indicated proportions and the resulting mixture was added all at once to a 1,000 ml flask. The mixture was then heated and stirred under a stream of nitrogen and at an oil bath temperature of 45° C. for about 15 hours, thereby forming a carbodiimide-containing composite particle solution.

The resulting particle solution was repeatedly washed and filtered three to five times with a water-methanol solvent mixture (weight ratio, 3:7) using a known suction filtration apparatus, then vacuum dried, yielding composite particles (Grafted Particles 1). The Grafted Particles 1 were measured using a Fourier transform infrared spectrophotometer (FT-IR8200PC, manufactured by Shimadzu Corporation; abbreviated below as “FT-IR”), whereupon an absorption peak due to carbodiimide groups was observed at a wavelength of about 2150 cm⁻¹, confirming that a carbodiimide group-containing polymer had been grafted.

| | |
|---|---|
| Core Particle 1 | 25.0 g |
| Solution obtained in Synthesis Example 6 | 115.4 g |
| Water | 136.7 g |
| Methanol | 506.4 g |

### Synthesis Example 9

Aside from using Core Particles 2 and the solution obtained in Synthesis Example 7, particles having grafted carbodiimide groups (Grafted Particles 2) were obtained by the same method as in Synthesis Example 8.

The Grafted Particles 2 were measured by FT-IR, whereupon an absorption peak due to carbodiimide groups was observed at a wavelength of about 2150 cm⁻¹, confirming that a carbodiimide group-containing polymer had been grafted.

### Synthesis Example 10

Aside from using Core Particles 3, particles having grafted carbodiimide groups (Grafted Particles 3) were obtained by the same method as in Synthesis Example 8.

The Grafted Particles 3 were measured by FT-IR, whereupon an absorption peak due to carbodiimide groups was observed at a wavelength of about 2150 cm⁻¹, confirming that a carbodiumide group-containing polymer had been grafted.

### Synthesis Example 11

Aside from using Core Particles 4, particles having grafted carbodiimide groups (Grafted Particles 4) were obtained by the same method as in Synthesis Example 8.

The Grafted Particles 4 were measured by FT-IR, whereupon an absorption peak due to carbodiumide groups was observed at a wavelength of about 2150 cm⁻¹, confirming that a carbodiimide group-containing polymer had been grafted.

### Synthesis Example 12

The starting compounds and other ingredients shown below were mixed in the indicated proportions and the resulting mixture was added all at once to a 300 ml flask. The mixture was then dispersed with a stirrer at room temperature for one hour. Next, 0.1 g of tributylamine was added as the catalyst, and heating was carried out under a stream of nitrogen and at an oil bath temperature of 70° C. for about 15 hours, thereby forming an epoxy-containing particle solution.

The resulting particle solution was repeatedly washed and filtered three to five times with a water-methanol solvent mixture (weight ratio, 3:7) using a known suction filtration apparatus, then vacuum dried, yielding composite particles (Grafted Particles 5). The Grafted Particles 5 were measured by FT-IR, whereupon an absorption peak due to epoxy groups was observed at a wavelength of about 910 cm⁻¹, confirming that an epoxy group-containing polymer had been grafted.

| | |
|---|---|
| Core Particle 1 | 12.0 g |
| Denacol EX-1610 | 11.9 g |
| Methanol | 33.2 g |
| Water | 62.3 g |
| (The Denacol EX-1610 was an epoxy compound produced by | |
| Nagase ChemteX Corporation and having an epoxy equivalent | |
| weight of 170.) | |

### Synthesis Example 13

Twenty grams of spherical silica particles having an average particle size of 0.2 μm (produced by Ube Nitto Kasei, Ltd.) were thoroughly dispersed in 80 g of dimethylformamide (DMF) within a 200 ml flask. Next, 0.4 g of 3-methacryloxypropyltrimethoxysilane (a silane coupling agent produced by Chisso Corporation) was added and stirring was carried out for 30 minutes at 70° C. AIBN (0.32 g), styrene (8.4 g) and methacrylic acid (3.6 g) were then added, after which the flask contents were heated at 70° C. for about 15 hours under stirring to effect the reaction.

Following reaction completion, the system was repeatedly washed with tetrahydrofuran (THF) and filtered about four times to remove unreacted monomer and ungrafted polymer, then dried, yielding particles (Grafted Particles 6). An IR spectrum of the Grafted Particles 6 was measured by FT-IR, whereupon absorption attributable to benzene rings was observed near 700 cm⁻¹ and absorption attributable to ester groups was observed near 1720 cm⁻¹. These results confirmed that a carboxyl group-bearing polymer (styrene-methacrylic acid copolymer) had grafted onto the particles. The number-average molecular weight was about 11,000, and the average carboxyl group equivalent weight (theoretical) was 287.

### Synthesis Example 14

Ten grams of alumina particles having an average particle size of 0.4 μm obtained by classifying alumina particles (produced by Admatechs Co., Ltd.) was thoroughly dispersed in 90 g of DMF within a 200 ml flask. Next, 0.2 g of 3-methacryloxypropyltrimethoxysilane was added and the system was stirred at 70° C. for 30 minutes. This was followed by the addition of 0.32 g of AIBN, 7.0 g of styrene and 3.0 g of methacrylic acid, after which heating was carried out at 70° C. for about 15 hours to effect the reaction.

Following reaction completion, particles (Grafted Particles 7) were obtained by carrying out the same procedure as in Synthesis Example 13. An IR spectrum of the Grafted Particles 7 was measured by FT-IR, whereupon absorption attributable to benzene rings was observed near 700 cm⁻¹ and absorption attributable to ester groups was observed near 1720 cm⁻¹. These results confirmed that a carboxyl group-bearing polymer (styrene-methacrylic acid copolymer) had grafted onto the particles. The number-average molecular weight was about 35,000, and the average carboxyl group equivalent weight (theoretical) was 287.

### Synthesis Example 15

Aside from using spherical silica particles having an average particle size of 9.9 μm (Ube Nitto Kasei, Ltd.), composite particles (Grafted Particles 8) were obtained by a method similar to that in Synthesis Example 14. An IR spectrum of the Grafted Particles 8 was measured by FT-IR, whereupon absorption attributable to benzene rings was observed near 700 cm⁻¹ and absorption attributable to ester groups was observed near 1720 cm⁻¹. These results confirmed that a carboxyl group-bearing polymer (styrene-methacrylic acid copolymer) had grafted onto the particles. The number-average molecular weight was about 35,000, and the average carboxyl group equivalent weight (theoretical) was 287.

### Syntesis Example 16

Aside from excluding methacrylic acid, composite particles (Grafted Particles 9) of styrene alone were produced by the same method as in Synthesis Example 13. An IR spectrum of the Grafted Particles 9 was measured by FT-IR, whereupon absorption attributable to benzene rings was observed near 700 cm⁻¹. These results confirmed that a polymer (polystyrene) had grafted onto the particles. The number-average molecular weight was approximately 11,000.

### (3) Production of Rough Particles for Plating or Vapor Deposition Treatment

### Example 1

The starting compounds and other ingredients shown below were added all at once in the indicated proportions to a 100 ml flask and ultrasonically dispersed, then heated and stirred under a stream of nitrogen and at an oil bath temperature of 45° C. for about 15 hours, thereby producing a rough particle solution.

The resulting particle solution was repeatedly washed and filtered three to five times with methanol using a known suction filtration apparatus to remove insolubles, then vacuum dried, yielding rough particles for plating or vapor deposition treatment (referred to below as “rough particles”). The shape of these particles was examined by SEM, whereupon they were found to be particle clusters having asperities formed by the bonding, at least at the surface, of three or more non-agglomerated, monodispersed primary particles. FIG. 1 shows a scanning electron micrograph of one of the rough particles thus obtained.

When the carbodiimide resin used in the production of Grafted Particles 1 and the styrene-methacrylic acid copolymer used in the production of Grafted Particles 6 were placed in the solvent ingredients used, both dissolved.

| | |
|---|---|
| Particle (A): Grafted Particle 1 | 5.0 g |
| Particle (B): Grafted Particle 6 | 0.5 g |
| THF | 31.5 g |
| Methanol | 9.75 g |
| Water | 5.25 g |

### Example 2

Aside from changing the (A) particles to Grafted Particles 2 and changing the (B) particles to Grafted Particles 7, rough particles were obtained by the same method as in Example 1.

The shapes of these particles were examined by SEM, whereupon they were found to be particle clusters having asperities formed by the bonding, at least at the surface, of three or more non-agglomerated, monodispersed primary particles.

When the carbodiimide resin used in the production of Grafted Particles 2 and the styrene-methacrylic acid copolymer used in the production of Grafted Particles 7 were placed in the solvent ingredients used, both dissolved.

### Example 3

Aside from changing the (A) particles to Grafted Particles 4, rough particles were obtained by the same method as in Example 1.

The shapes of these particles were examined by SEM, whereupon they were found to be particle clusters having asperities formed by the bonding, at least at the surface, of three or more non-agglomerated, monodispersed primary particles.

### Example 4

The starting compounds and other ingredients shown below were added all at once in the indicated proportions to a 100 ml flask and ultrasonically dispersed, following which 0.05 g of tributylamine was added as the catalyst and heating was carried out under a stream of nitrogen and at an oil bath temperature of 55° C. for about 15 hours, thereby producing a rough particle solution.

The resulting particle solution was repeatedly washed and filtered three to five times with methanol using a known suction filtration apparatus to remove insolubles, then vacuum dried, yielding composite particles. The shape of these particles was examined by SEM, whereupon they were found to be particle clusters having asperities formed by the bonding, at least at the surface, of three or more non-agglomerated, monodispersed primary particles.

When the epoxy compound used in the production of Grafted Particles 5 and the styrene-methacrylic acid copolymer used in the production of Grafted Particles 6 were placed in the solvent ingredients used, both dissolved.

| | |
|---|---|
| Particle (A): Grafted Particle 5 | 5.0 g |
| Particle (B): Grafted Particle 6 | 0.5 g |
| THF | 31.5 g |
| Methanol | 9.75 g |
| Water | 5.25 g |

### Example 5

Aside from changing the (A) particles to Grafted Particles 8 and changing the (B) particles to Grafted Particles 3, rough particles obtained by the same method as in Example 1. The shapes of these particles were examined by SEM, whereupon they were found to be particle clusters having asperities formed by the bonding, at least at the surface, of three or more non-agglomerated, monodispersed primary particles.

When the carbodiimide resin used in the production of Grafted Particles 3 and the styrene-methacrylic acid copolymer used in Grafted Particles 8 were placed in the solvent ingredients used, both dissolved.

### Comparative Example 1

The starting materials shown below were added all at once in the indicated proportions to a 100 ml flask and ultrasonically dispersed, following which heating was carried out under a stream of nitrogen and at an oil bath temperature of 50° C. for about 15 hours, thereby producing a rough particle solution.

The resulting particle solution was repeatedly washed and filtered three to five times with methanol using a known suction filtration apparatus to remove insolubles, then vacuum dried, yielding composite particles. The shape of these particles was examined by SEM, whereupon almost no particles having asperities at the surface were found to be present.

| | |
|---|---|
| Core Particle 5 (polystyrene alone) | 5.0 g |
| Grafted Particle 6 | 0.5 g |
| Methanol | 49.5 g |

### Comparative Example 2

Aside from changing the (B) particles to Grafted Particles 9, rough particles were obtained in the same way as in Example 1. The shape of these particles was examined by SEM, whereupon some particles having asperities at the surface were obtained.

### Comparative Example 3

The starting materials shown below were added all at once in the indicated proportions to a 100 ml flask, 0.03 g of a cationic surfactant (Cation ABT₂; produced by NOF Corporation) was added, and the flask contents were ultrasonically dispersed. Next, 1.5 g of the spherical silica particles used in Synthesis Example 13 were added, following which the contents were stirred with a stirrer for about 15 hours, thereby producing a rough particle solution using polar adsorption.

As in Comparative Example 1, the resulting particle solution was repeatedly washed and filtered to remove insolubles, then vacuum dried, yielding composite particles. The shape of these particles was examined by SEM, whereupon rough particles were obtained in which three or more non-agglomerated, monodispersed primary particles had bonded at the surface, albeit in a somewhat unbalanced manner.

| | |
|---|---|
| Core Particle 1 | 15.0 g |
| Methanol | 48.0 g |
| Water | 12.0 g |

Above Examples 1 to 5 and Comparative Examples 1 to 3 are summarized in Table 1 below.

TABLE 1

| | Compound grafted at | | | Compound grafted at | | | |
|---|---|---|---|---|---|---|---|
| | surface of particle (A) | | | surface of particle (B) | | | |
| | | | Number- | | | Number- | |
| | | | average | | | average | Formation |
| | Functional | Equivalent | molecular | Functional | Equivalent | molecular | of |
| | group | weight | weight | group | weight | weight | asperities |
| Example 1 | carbodiimide | 265 | 1,852 | carboxyl | 287 | 11,000 | Very good |
| Example 2 | carbodiimide | 336 | 3,364 | carboxyl | 287 | 11,000 | Very good |
| Example 3 | carbodiimide | 265 | 1,852 | carboxyl | 287 | 11,000 | Very good |
| Example 4 | epoxy | 170 | >500 | carboxyl | 287 | 35,000 | Very good |
| Example 5 | carboxyl | 287 | 35,000 | carbodiimide | 265 | 1,852 | Very good |

| | | | | | |
|---|---|---|---|---|---|
| Comparative | no surface functional groups | carboxyl | 287 | 11,000 | Very poor |
| Example 1 | (polystyrene) | | | | |

| | | | | | | |
|---|---|---|---|---|---|---|
| Comparative | carbodiimide | 265 | 1,852 | grafted | 11,000 | Poor |
| Example 2 | | | | (polystyrene) | | |

| | | | |
|---|---|---|---|
| Comparative | surface cationic treatment | silica particles | Good |
| Example 3 | | | |

Very Good: Adhesion and shape both good
Good: Adhesion good
Poor: Some adhesion
Very Poor: Substantially no adhesion

The degree of bonding by the protruding particles in the rough particles obtained in above Examples 1 to 5 and Comparative Examples 2 and 3 were evaluated as described below. The results are shown in Table 2.

### Evaluating the Degree of Bonding by Protruding Particles

One gram of the rough particles obtained in the respective examples was placed in 100 ml of a water-methanol solvent mixture (weight ratio, 3:7), subjected to vibration or impact for 5 minutes with a homogenizer (US-150T; manufactured by Nissei Corporation), then transferred to a 300 ml flask. Within this flask, another 100 ml of a water-methanol solvent mixture (weight ratio, 3:7) was added and stirring was carried out at 400 rpm for 3 hours using a crescent-shaped stirring blade having a length of 8 cm, thereby imparting a shearing action to the particles. The flask contents were then filtered twice using a known suction filtration apparatus, and vacuum dried to give the particles. The shape of the particles was examined by SEM, and the degree of bonding by the protruding particles was evaluated.

TABLE 2

| | Particle shape | Particle shape | Results of |
|---|---|---|---|
| | (before test) | (after test) | evaluation |
| Example 1 | rough | rough | Very good |
| Example 2 | rough | rough | Very good |
| Example 3 | rough | rough | Very good |
| Example 4 | rough | rough | Good |
| Example 5 | rough | rough | Very good |
| Comparative | partly rough | substantially | Very poor |
| Example 2 | | no protrusions | |
| Comparative | rough | partly rough | Poor |
| Example 3 | | | |

Very Good: Had same degree of protrusions as before test
Good: Small decrease in number of adhering particles
Poor: Large decrease in number of adhering particles
Very Poor: Substantially no adhering particles

As shown in Table 2, in the rough particles obtained in Examples 1 to 5 according to the invention, because the (A) particles and the (B) particles were united by chemical bonds via the functional groups, the protrusions thereon had excellent bond strengths. By contrast, in the rough particles obtained in Comparative Examples 2 and 3, the bond strengths of the protrusions were clearly inferior. Moreover, from the results in Example 1 to 5 of the invention, it is apparent that when the functional groups on either of or both the (A) particles and the (B) particles are carbodiimide groups, the bond strength of the protrusions is improved compared to when there are no carbodiimide groups at all.

### (4) Production of Electrically Conductive Rough Particles

### Reference Example 1

Three grams of the rough particles obtained in Example 1 were washed using a commercial cleaner, thereby obtaining surface-modified particles (modification was carried out according to the method described in JP-A 61-64882). Next, the surface-modified rough particles were immersed for 5 minutes in an aqueous solution composed of 10 g of stannous chloride, 40 ml of hydrochloric acid and 1,000 ml of water, following which filtration and washing were carried out. The filtered particles were added under stirring to 200 ml of a known catalyzing solution (0.5 g of palladium chloride, 25 g of stannous chloride, 300 ml of hydrochloric acid, and 600 ml of water) and stirred for 5 minutes to allow the pick up of palladium ions by the particles. Next, the particles were filtered and washed with 10 wt % hydrochloric acid (aqueous), then subjected to reduction treatment by 5 minutes of immersion in an ambient-temperature 1 g/L sodium phosphite solution in water, thereby supporting the palladium on the surface of the rough particles.

The palladium-supporting rough particles were then collected by filtration, and the particles obtained were dispersed in 100 ml of pure water, following which the dispersion was poured into 900 ml of an electroless plating solution (solution temperature, 90° C.; pH, 4.6; metal ion concentration, as nickel: 0.75 g/L) under stirring. After the plating reaction (approx. 15 minutes) had stopped, the plating solution was filtered and the material collected by filtration was washed three times with 10 wt % hydrochloric acid (aqueous), then vacuum dried at 100° C., yielding electrically conductive particles having a nickel film.

### Reference Examples 2 to 5

Aside from using the rough particles obtained in Examples 2 to 5, electrically conductive particles were obtained by carrying out the same treatment as in Reference Example 1.

### Reference Examples 6 and 7

Aside from using the rough particles obtained in Comparative Examples 2 and 3, electrically conductive particles were obtained by carrying out the same treatment as in Reference Example 1.

### Confirming the Degree of Bonding by Protruding Particles after Plating Treatment

The shape of the conductive particles obtained in each of the reference examples was examined by SEM, and the degree of binding by the protrusions was evaluated.

As a result, the conductive particles obtained in Reference Examples 1 to 5 were found to substantially reflect the asperities on the rough particles prior to plating treatment, demonstrating that the rough particles had strongly bonded protrusions capable of withstanding plating treatment and were thus suitable for plating treatment. On the other hand, the electronically conductive particles obtained in Reference Examples 6 and 7 either lost asperities or retained only some of the asperities as a result of plating treatment, indicating that they were not particles suitable for plating treatment.

The thickness of the nickel film layers obtained in Reference Examples 1 to 7 were measured with a scanning transmission electron microscope (S-4800; manufactured by Hitachi, Ltd.). Those in Reference Examples 1 to 5 were all found to have an average thickness of at least 0.1 μm.

1. A rough particle for plating or vapor deposition, characterized by comprising (A) a particle having on a surface thereof a first functional group and (B) a particle having on a surface thereof a second functional group capable of reacting with the first functional group and having an average particle size of at least 0.1 μm but less than the average particle size of particle (A), which (A) and (B) particles are united by chemical bonds between the first and second functional groups;
wherein the surface of the (A) particle has at least two protrusions thereon.

2. The rough particle for plating or vapor deposition of claim 1, characterized in that the chemical bonds are covalent bonds.

3. The rough particle for plating or vapor deposition of claim 1, characterized in that the (A) particle or the (B) particle or both have a functional group-containing polymeric compound grafted from the surface thereof.

4. The rough particle for plating or vapor deposition of claim 3, characterized in that the functional group-containing polymeric compound has a number-average molecular weight of from 500 to 100,000.

5. The rough particle for plating or vapor deposition of claim 3, characterized in that the functional group-containing polymeric compound has an average of at least two functional groups per molecule.

6. The rough particle for plating or vapor deposition of claim 5, characterized in that the functional group-containing polymeric compound has a functional group equivalent weight of from 50 to 2,500.

7. The rough particle for plating or vapor deposition of claim 1, characterized in that the first functional group or the second functional group or both is at least one selected from the group consisting of active hydrogen groups, carbodiimide groups, oxazoline groups and epoxy groups.

8. The rough particle for plating or vapor deposition of claim 7, characterized in that the first functional group or the second functional group or both is a carbodiimide group.

9. The rough particle for plating or vapor deposition of claim 1, characterized in that the (B) particle has an average particle size of from 0.15 to 30 μm.

10. The rough particle for plating or vapor deposition of claim 1, characterized in that the (A) particle is a spherical or substantially spherical particle.

11. The rough particle for plating or vapor deposition of claim 1, characterized in that the (A) particle is an organic polymer particle.

12. The rough particle for plating or vapor deposition of claim 1, characterized in that the (A) particle has an average particle size of from 0.5 to 100 μm.
